(19) United States
(12) Patent Application Publication
(10) Pub. No.: US 2024/0150593 A1
(43) Pub. Date: May 9, 2024

(54) SYSTEMS AND METHODS FOR TREATING A SUBSTRATE

(71) Applicant: PPG Industries Ohio, Inc., Cleveland, OH (US)

(72) Inventors: Corey James DeDomenic, Trafford, PA (US); Kristi Maree Allen, Pittsburgh, PA (US); Elizabeth Stephenie Brown-Tseng, Gibsonia, PA (US); Peter Lawrence Votruba-Drzal, Pittsburgh, PA (US); Silvia Bezer, Gibsonia, PA (US); Michael Gerard Olah, Pittsburgh, PA (US); Steven Edward Bowles, Pittsburgh, PA (US); Mary Lyn Chong Lim, Allison Park, PA (US); Mark William McMillen, Cabot, PA (US)

(73) Assignee: PPG Industries Ohio, Inc., Cleveland, OH (US)

(21) Appl. No.: 18/549,005

(22) PCT Filed: Mar. 4, 2022
(86) PCT No.: PCT/US2022/070955

§ 371 Date: Sep. 5, 2023

Related U.S. Application Data
(60) Provisional application No. 63/157,002, filed on Mar. 5, 2021.
(60) Provisional application No. 63/157,010, filed on Mar. 5, 2021.

(51) Int. Cl. C09D 7/61; C09D 5/08; C09D 5/44; C09D 133/02

(52) U.S. Cl. CPC C09D 7/61; C09D 5/08; C09D 5/4407; C09D 133/02

(57) ABSTRACT

Disclosed is a sealing composition for treating a metal substrate comprising: a polyolefin component; and a colloidal layered silicate. Also disclosed is a system for treating a metal substrate comprising: a cleaner composition; and/or a pretreatment composition for treating at least a portion of the substrate, the pretreatment composition comprising a Group IVB metal; and a sealing composition for treating at least a portion of the substrate treated with the cleaner composition and/or the pretreated composition, the sealing composition comprising a polyolefin component. Also disclosed is a method of treating a substrate comprising contacting at least a portion of a surface of the substrate with any of the compositions disclosed herein or any of the systems disclosed herein. Also disclosed is a method of treating a substrate comprising passing electric current between a cathode and the substrate, serving as an anode, said cathode and anode being immersed in a sealing composition comprising a polyolefin component. Also disclosed is a substrate comprising a surface treated with any of the compositions disclosed herein, any of the systems disclosed herein, or any of the methods disclosed herein.

### FIELD

The present disclosure relates to compositions, systems, and methods for treating a substrate.

### BACKGROUND

The use of protective coatings on metal substrates for improved corrosion resistance is common. Conventional techniques for coating such substrates include techniques that involve pretreating the metal substrate with chromium-containing compositions. The use of such chromate-containing compositions, however, imparts environmental and health concerns.

### SUMMARY

Disclosed herein is a sealing composition for treating a metal substrate comprising: a polyolefin component; and a colloidal layered silicate.

Also disclosed is a system for treating a metal substrate comprising: a cleaner composition; and/or a pretreatment composition for treating at least a portion of the substrate, the pretreatment composition comprising a Group IVB metal; and a sealing composition for treating at least a portion of the substrate treated with the cleaner composition and/or the pretreated composition, the sealing composition comprising a polyolefin component.

Also disclosed is a method of treating a substrate comprising contacting at least a portion of a surface of the substrate with any of the compositions disclosed herein or any of the systems disclosed herein.

Also disclosed is a method of treating a substrate comprising passing electric current between a cathode and the substrate, serving as an anode, said cathode and anode being immersed in a sealing composition comprising a polyolefin component.

Also disclosed is a substrate comprising a surface treated with any of the compositions disclosed herein, any of the systems disclosed herein, or any of the methods disclosed herein.

### DETAILED DESCRIPTION

For purposes of the following detailed description, it is to be understood that the disclosure may assume various alternative variations and step sequences, except where expressly specified to the contrary. Moreover, other than in any operating examples, or where otherwise indicated, all numbers such as those expressing values, amounts, percentages, ranges, subranges and fractions may be read as if prefaced by the word “about,” even if the term does not expressly appear. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Where a closed or open-ended numerical range is described herein, all numbers, values, amounts, percentages, subranges and fractions within or encompassed by the numerical range are to be considered as being specifically included in and belonging to the original disclosure of this application as if these numbers, values, amounts, percentages, subranges and fractions had been explicitly written out in their entirety.

Notwithstanding that the numerical ranges and parameters set forth the broad scope of the disclosure are approximations, the numerical values set forth in the specific examples are reported as precisely as possible. Any numerical value, however, inherently contains certain errors necessarily resulting from the standard variation found in their respective testing measurements.

As used herein, unless indicated otherwise, a plural term can encompass its singular counterpart and vice versa, unless indicated otherwise. For example, although reference is made herein to “a” Group IVB metal and “a” polyolefin, a combination (i.e., a plurality) of these components can be used.

In addition, in this application, the use of “or” means “and/or” unless specifically stated otherwise, even though “and/or” may be explicitly used in certain instances.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient, or method step. As used herein, “consisting essentially of” is understood in the context of this application to include the specified elements, materials, ingredients, or method steps “and those that do not materially affect the basic and novel characteristic(s)” of what is being described. As used herein, open ended terms include closed terms, such as “consisting essentially of” and “consisting of.”

As used herein, the terms “on,” “onto,” “applied on,” “applied onto,” “formed on,” “deposited on,” “deposited onto,” mean formed, overlaid, deposited, or provided on but not necessarily in contact with the surface. For example, a coating composition “applied onto” a substrate does not preclude the presence of one or more intervening coating layers of the same or different composition located between the coating composition and the substrate.

As used herein, a “salt” refers to an ionic compound made up of metal cations and non-metallic anions and having an overall electrical charge of zero. Salts may be hydrated or anhydrous.

As used herein, “composition” refers to a solution, mixture, or dispersion in a medium.

As used herein, “aqueous composition” refers to a solution or dispersion in a medium that comprises predominately water. For example, the aqueous medium may comprise water in an amount of more than 50 wt. %, or more than 70 wt. %, or more than 80 wt. %, or more than 90 wt. %, or more than 95 wt. %, based on the total weight of the medium. That is, the aqueous medium may for example consist substantially of water.

As used herein, the term “dispersion” refers to a two-phase transparent, translucent, or opaque system in which particles are in the dispersed phase and an aqueous medium, which includes water, is in the continuous phase.

As used herein, “system” refers to a plurality of treatment compositions (including cleaners and rinses) used to treat a substrate and to produce a treated substrate. The system may be part of a production line (such as a factory production line) that produces a finished substrate or a treated substrate that is suitable for use in other production lines.

As used herein, “pretreatment composition” refers to a composition that is capable of reacting with and chemically altering the substrate surface and binding to it to form a film that affords corrosion protection.

As used herein, “pretreatment bath” refers to an aqueous bath containing the pretreatment composition and that may contain components that are byproducts of the process.

As used herein, “cleaner composition” refers to a composition that removes oil, soil, and other contaminants from a substrate surface and that optionally is capable of etching or oxidizing the substrate surface.

As used herein, the “cleaner composition bath” refers to an aqueous bath containing a cleaner composition and that may contain components that are byproducts of the process.

As used herein, “sealing composition” refers to a composition that affects a substrate surface or a material deposited onto a substrate surface in such a way as to alter the physical and/or chemical properties of the substrate surface, e.g., the composition affords corrosion protection.

As used herein, “sealing composition bath” or “seal bath” refers to an aqueous bath containing a sealing composition and that may contain components that are byproducts of the process.

As used herein, “copolymer” refers to a polymer comprising the residue of two or more different monomers.

As used herein, “block-copolymer” refers to a copolymer chain containing two or more uninterrupted sections of a consistent monomer composition with distinct boundaries between the sections.

As used herein, “alternating-copolymer” refers to a copolymer containing two or more monomer species distributed in an alternating sequence.

As used herein “statistical-copolymer” refers to a copolymer containing a sequential distribution of monomer which obeys known statistical laws, such as the Markovian statistics of zeroth order, first order, second order, or higher order reaction rates.

As used herein, “gradient-copolymer” refers to a copolymer that exhibits a gradual change in monomer composition for predominately one monomer composition to predominately a different monomer composition.

As used herein, “random-copolymer” refers to a copolymer with random distribution of monomer units along the polymer chain, such that the polymer architecture could not be classified as a block-copolymer, an alternating-copolymer, a statistical-copolymer, or a gradient-copolymer.

As used herein, “graft-copolymer” refers to a branched copolymer wherein the main chain and branches have different monomer compositions. The main chain and branches may be homopolymers or copolymers, and if copolymers, may be block-copolymers, alternating-copolymers, statistical-copolymers, random-copolymers, and/or gradient-copolymers.

As used herein, the terms “Group IA metal” and “Group IA element” refer to an element that is in Group IA of the CAS version of the Periodic Table of the Elements as is shown, for example, in the Handbook of Chemistry and Physics, 63^{rd} edition (1983), corresponding to Group 1 in the actual IUPAC numbering.

As used herein, the term “Group IA metal compound” refers to compounds that include at least one element that is in Group IA of the CAS version of the Periodic Table of the Elements.

As used herein, “spontaneous” refers to a composition that is capable of depositing on a substrate surface to form a layer in the absence of an externally applied voltage.

As used herein, “electrodepositable” refers to a composition comprising a cationic or an anionic salt group-containing film-forming polymer, wherein the polymer is capable of depositing on a substrate surface to form a layer upon the introduction of an externally applied voltage. For clarity, an electrodepositable composition may further comprise additional materials that also may deposit on a substrate surface upon introduction of the externally applied voltage.

As used herein, the terms “Group IVB metal” and “Group IVB element” refer to an element that is in Group IVB of the CAS version of the Periodic Table of the Elements as is shown, for example, in the Handbook of Chemistry and Physics, 63^{rd} edition (1983), corresponding to Group 4 in the actual IUPAC numbering.

As used herein, the term “Group IVB metal compound” refers to compounds that include at least one element that is in Group IVB of the CAS version of the Periodic Table of the Elements.

As used herein, the terms “Group VIB metal” and “Group VIB element” refer to an element that is in Group VIB of the CAS version of the Periodic Table of the Elements as is shown, for example, in the Handbook of Chemistry and Physics, 63^{rd} edition (1983), corresponding to Group 6 in the actual IUPAC numbering.

As used herein, the term “colloidal layered silicate” means a natural or synthetic smectite clay mineral of the phyllosilicate species.

As used herein, the term “smectite clay” refers to clay having a variable net negative charge which is balanced by a positive charge adsorbed externally on interlamellar surfaces.

As used herein, the term “rheology modifier” refers to a material that, when added to the sealing composition, modifies, for example, the rheological properties of a fluid, such as imparting shear thinning properties, shear thickening properties, thixotropic properties, and the like.

As used herein, the term “melt index” refers to a measured property of polymers and thermoplastics used as an assessment of viscosity, average molecular weight and other physical and chemical properties and is defined according to ASTM D1238 as the mass in grams of polymer that flows from a standardized die 10 minutes when a 2.16 kg piston is applied as a load at a temperature of 190° C.

As used herein, the term “acid weight percent” refers to the weight percentage of acid-functional monomer on polymer solids measured according to ASTM D4094 (adjusted for measurement of specific acid-functional monomers and copolymers).

As further defined herein, ambient conditions generally refer to room temperature and humidity conditions or temperature and humidity conditions that are typically found in the area in which the coating composition is being applied to a substrate, e.g., at 10° C. to 40° C. and 5% to 80% relative humidity.

As used herein, unless indicated otherwise, the term “substantially free” means that a particular material is not purposefully added to a mixture or composition, respectively, and is present only as an impurity in a trace amount of less than 2% by weight based on a total weight of the mixture or composition, respectively. As used herein, unless indicated otherwise, the term “essentially free” means that a particular material is present only in an amount of less than 0.5% by weight based on a total weight of the mixture or composition, respectively. As used herein, unless indicated otherwise, the term “completely free” means that a mixture or composition, respectively, does not comprise a particular material, i.e., the mixture or composition comprises 0% by weight of such material, or that such material is below the detection limit of common analytical techniques.

Unless otherwise disclosed herein, as used herein, the terms “total composition weight,” “total weight of a composition,” or similar terms refer to the total weight of all ingredients being present in the respective composition including any carriers and solvents.

As mentioned above, the present disclosure is directed to a sealing composition for treating a metal substrate comprising, or consisting essentially of, or consisting of, a polyolefin component. As described in more detail below, the composition may comprise, or may consist essentially of, or may consist of, the polyolefin component and a colloidal layered silicate and/or a Group IVB metal.

The present disclosure also is directed to a system for treating a metal substrate comprising: a cleaner composition; and/or a pretreatment composition for treating at least a portion of the substrate, the pretreatment composition comprising a Group IVB metal; and a sealing composition for treating at least a portion of the substrate treated with the cleaner composition and/or the pretreated composition, the sealing composition comprising a polyolefin component.

The present disclosure also is directed to a method of treating a substrate comprising contacting at least a portion of a surface of the substrate with any of the compositions disclosed herein or any of the systems disclosed herein.

The present disclosure also is directed to a method of treating a substrate comprising passing electric current between a cathode and the substrate, serving as an anode, said cathode and anode being immersed in a sealing composition comprising a polyolefin component.

The present disclosure also is directed to a substrate comprising a surface treated with any of the compositions disclosed herein, any of the systems disclosed herein, or any of the methods disclosed herein.

### Sealing Compositions

The polyolefin component may comprise one or more polyolefin materials. At least one of the polyolefin materials may also be a rheology modifier. A “polyolefin” will be understood as referring to a polymer derived from the polymerization of at least one olefinic hydrocarbon; that is, a hydrocarbon containing a carbon-carbon double bond. The polyolefin component may comprise copolymers. Such copolymers may be alternating-copolymers, statistical-copolymers, random-copolymers, gradient-copolymers, or graft-copolymers. Examples of suitable polyolefins include, but are not limited to, homopolymers and copolymers (including elastomers) of one or more olefins such as ethylene, propylene, 1-butene, 3-methyl-1-butene, 4-methyl-1-pentene, 3-methyl-1-pentene, 1-heptene, 1-hexene, 1-octene, 1-decene, and 1-dodecene, as typically represented by polyethylene, polypropylene, poly-1-butene, poly-3-methyl-1-butene, poly-3-methyl-1-pentene, poly-4-methyl-1-pentene, ethylene-propylene copolymer, ethylene-1-butene copolymer, and propylene-1-butene copolymer; copolymers (including elastomers) of an alpha-olefin with a conjugated or non-conjugated diene, such as ethylene-butadiene copolymer and ethylene-ethylidene norbornene copolymer; and polyolefins (including elastomers) such as copolymers of two or more alpha-olefins with a conjugated or non-conjugated diene, examples of which include ethylene-propylene-butadiene copolymer, ethylene-propylene-dicyclopentadiene copolymer, ethylene-propylene-1,5-hexadiene copolymer, and ethylene-propylene-ethylidene norbornene copolymer; ethylene-vinyl compound copolymers such as ethylene-vinyl acetate copolymer, ethylene-vinyl alcohol copolymer, ethylene-vinyl chloride copolymer, ethylene acrylic acid or ethylene-(meth)acrylic acid copolymers, and ethylene-(meth)acrylate copolymer. Any of the above polyolefins can contain functionality, such as hydroxyl, amine, ether, acid, anhydride, amide, and/or ester groups. The anhydride-functional polyolefin copolymers may be further reacted with water or a suitable alcohol or amine reagent to generate a resulting acid-functional polyolefin copolymer.

The polyolefin component may thus comprise one or more acid-functional polyolefins. Acid functionality can be derived by copolymerization of one or more ethylenically unsaturated monomers having one or more acidic functional groups such as carboxyl groups or phosphoric groups. Non-limiting acid functional ethylenically unsaturated monomers include, for example, (meth)acrylic acid and acrylic acid. Accordingly, the polyolefin component may comprise an acrylic resin, obtainable by copolymerization of at least one or more olefin monomers with (meth)acrylic acid and/or derivatives thereof such as (meth)acrylate monomers. As used herein, the terms “(meth)acrylic acid,” “(meth)acrylate,” and the like refer collectively to acrylic acid and methacrylic acid, or acrylates and methacrylates, respectively. An example of an acid functional polyolefin is an ethylene acrylic acid copolymer. Examples of acid-functional and/or anhydride-functional polyolefin copolymers include, but are not limited to, ethylene-maleic anhydride copolymers, propylene-maleic anhydride copolymers, ethylene-(meth)acrylic acid copolymers, 1-octene-maleic anhydride copolymers, 1-octadene-maleic anhydride copolymers, isobutylene-maleic anhydride copolymers, isoprene-maleic anhydride copolymers, or ethylene-acrylic acid (EAA) copolymers. Suitable examples of such functionalized polyolefins include those commercially available under the trademarks PRIMACOR®-available from Dow, NUCREL™ available from E.I. DuPont de Nemours, and ESCOR™ available from ExxonMobil Chemical Company and described in U.S. Pat. Nos. 4,599,392, 4,988,781, and 5,938,437. The acid functionality may render the polyolefin dispersible or dissolvable in a carrier medium such as water. The acid functional polyolefin may be at least partially neutralized with a base such as an amine for promoting dispersion or dissolution.

The polyolefin can be included in the composition according to the present disclosure in any form. For example, the polyolefin can be in the form of a dispersion. A polyolefin dispersion can be prepared by melting the polyolefin above its melting point in a vessel capable of holding pressures necessary to add carrier medium (such as water in the presence of a base, such as an amine) while mixing at elevated temperatures, i.e., temperatures above ambient temperature, such as more than 40° C. The amine and the carrier may be present in the composition in a combined amount of 0 percent by weight based on total weight of the sealing composition, such as at least 20 percent by weight, such as at least 40 percent by weight, such as at least 50 percent by weight, such as at least 60 percent by weight, such as at least 70 percent by weight, such as at least 75 percent by weight. The amine and the carrier may be present in a combined amount of no more than 99.75 by weight based on total weight of the sealing composition, such as no more than 99 percent by weight, such as no more than 97 percent by weight, such as no more than 96 percent by weight such as no more than 90 percent by weight, such as no more than 89 percent by weight. The amine and the carrier may be present in a combined amount of 20 percent by weight to 96 percent by weight based on total weight of the sealing composition, such as 40 percent by weight to 89 percent by weight, such as 60 percent by weight to 99.75 percent by weight, such as 70 percent by weight to 99 percent by weight, such as 0 percent by weight to 97 percent by weight, such as 50 percent by weight to 90 percent by weight, such as 75 percent by weight to 90 percent by weight.

Suitable polyolefin dispersions are also commercially available from Dow Chemical as Generic Polyolefin Dispersion TYPE 5453. In other examples, the polyolefin used according to the present disclosure can also be used in solution form. An example of this is an acid containing polyolefin, such as PRIMACOR 5980I commercially available from Dow Chemical. PRIMACOR can be heated in the presence of water and amine, such as enough amine to achieve a level of neutralization that will allow formation of the solution.

The polyolefin component may have a melt index of at least 1 g/10 min measured according to ASTM D1238 at conditions of 125° C./2.16 kg, such as at least 2.5 g/10 min, such as at least 150 g/10 min, such as at least 200 g/10 min, such as at least 750 g/10 min, and may have a melt index of no more than 2000 g/10 min measured according to ASTM D1238 at conditions of 125° C./2.16 kg, such as no more than 1500 g/10 min, such as no more than 500 g/10 min, such as no more than 10 g/10 min. The polyolefin component may have a melt index of 1 g/10 min to 2000 g/10 min measured according to ASTM D1238 at conditions of 125° C./2.16 kg, such as 2.5 g/10 min to 10 g/10 min, such as 150 g/10 min to 1500 g/10 min, such as 750 g/10 min to 1500 g/10 min, such as 200 g/10 min to 500 g/10 min. The melt index can range between the recited values inclusive of the recited values.

The polyolefin may have an acid weight percent of at least 2.5 weight % measured according to ASTM 4094 or an equivalent accuracy, such as at least 5 weight %, such as at least 15 weight %, and may have an acid weight percent of no more than 35 weight % measured according to ASTM 4094 or an equivalent accuracy, such as no more than 30 weight %, such as no more than 25 weight %. The polyolefin may have an acid weight percent of 2.5 weight % to 35 weight % measured according to ASTM 4094 or an equivalent accuracy, such as 5 weight % to 30 weight %, such as 15 weight % to 25 weight %. The acid weight percent can range between the recited values inclusive of the recited values.

The amount of polyolefin component in the sealing composition can be at least 3 percent by weight based on total weight of the sealing composition, such as at least 10 percent by weight. The amount of polyolefin component in the sealing composition can be no more than 40 percent by weight based on total weight of the sealing composition, such as no more than 30 percent by weight. The amount of polyolefin component in the sealing composition can be 3 percent by weight to 40 percent by weight based on total weight of the sealing composition, such as 10 percent by weight to 30 percent by weight.

The sealing composition may further include a colloidal layered silicate, often referred to as synthetic hectorite clay. Colloidal layered silicates that are suitable for use in the compositions described herein include, for example, LAPONITE RD, LAPONITE RDS, LAPONITE XL21 and LAPONITE JS, each of which is commercially available from BYK, including combinations thereof. LAPONITE RD is a free-flowing synthetic layered silicate having a bulk density of 1,000 kg/m³, a surface area (BET) of 370 m²/g, a pH of a 2% suspension in water of 9.8, wherein the composition on a dry basis by weight is 59.5% SiO₂, 27.5% MgO, 0.8% Li₂O, and 2.8% Na₂O. LAPONITE RDS is also a free-flowing synthetic layered silicate having a bulk density of 1,000 kg/m³, a surface area (BET) of 330 m²/g, a pH of a 2% suspension in water of 9.7, wherein the composition on a dry basis by weight is 54.5% SiO₂, 26.0% MgO, 0.8% Li₂O, 5.6% Na₂O, and 4.1% P₂O₅. LAPONITE XL21 is sodium magnesium fluorosilicate. The particle size of the colloidal layered silicates, such as those described above, may be 1 nm to 2 μm in average diameter. Suitable methods of measuring particle sizes disclosed herein include, for example, transmission electron microscopy (TEM). Suitable methods of measuring clay particle size by TEM include suspending particles in a solvent and then drop-casting the suspension into a TEM grid which is allowed to dry under ambient conditions. For example, clay particles may be diluted in water for drop casting and measurements may be obtained from images acquired from a Tecnai T20 TEM operating at 200 kV and analyzed using ImageJ software or an equivalent solvent, instrument, and software.

The colloidal layered silicate may be present in the sealing composition in an amount of at least 0.25 percent by weight based on total weight of the sealing composition, such as at least 0.50 percent by weight, such as at least 1 percent by weight, and may be present in the sealing composition in an amount of no more than 25 percent by weight based on total weight of the sealing composition, such as no more than 5 percent by weight, such as no more than 2.5 percent by weight. The colloidal layered silicate may be present in the sealing composition in an amount of 0.25 percent by weight to 25 percent by weight based on total weight of the sealing composition, such as 0.5 percent by weight to 5 percent by weight, such as 1 percent by weight to 2.5 percent by weight.

The sealing composition optionally may further include a rheology modifier that is not a polyolefin-containing component or a colloidal layered silicate. As a result, the sealing composition exhibits improved flow behavior in dip or immersion processes and panels treated with the sealing composition have more even film coverage and less fat edges and less pull away from edges. Any suitable rheology modifier may be used. In examples, the rheology modifier may comprise polyurethanes, acrylic polymers, latex, styrene/butadiene, polyvinylalcohol, cellulose-based materials such as carboxymethyl cellulose, methyl cellulose, (hydroxypropyl)methyl cellulose or gelatin, gums such as guar and xanthan, silicas such as fumed silica, or combinations thereof.

The rheology modifier, if present at all, may be present in the sealing composition in an amount of at least 0.5 percent by weight based on total solids weight of the sealing composition, such as at least 1 percent by weight, such as at least 10 percent by weight. The rheology modifier may be present in the sealing composition in an amount of no more than 50 percent by weight based on total solids weight of the sealing composition, such as no more than 40 percent by weight, such as no more than 30 percent by weight, such as no more than 25 percent by weight. The rheology modifier may be present in the sealing composition in an amount of 0.5 percent by weight to 50 percent by weight based on total solids weight of the sealing composition, such as 1 percent by weight to 40 percent by weight, such as 10 percent by weight to 30 percent by weight, such as 10 percent by weight to 25 percent by weight.

The sealing composition optionally may further comprise a Group IVB metal. The Group IVB metal may comprise zirconium, titanium, hafnium, or combinations thereof. For example, the Group IVB metal used in the first pretreatment composition may be a compound of zirconium, titanium, hafnium, or a mixture thereof. Suitable compounds of zirconium include, but are not limited to, hexafluorozirconic acid, alkali metal and ammonium salts thereof, zirconium tetrafluoride, ammonium zirconium carbonate, zirconium silicate, zirconium carboxylates and zirconium hydroxy carboxylates, such as zirconium acetate, zirconium oxalate, ammonium zirconium glycolate, ammonium zirconium lactate, ammonium zirconium citrate, zirconium basic carbonate, and mixtures thereof. Suitable compounds titanium include, but are not limited to, fluorotitanic acid and its salts. A suitable compound of hafnium includes, but is not limited to, hafnium nitrate.

The Group IVB metal may be present in the sealing composition in a total amount of at least 0.002 percent by weight of metal based on total weight of the sealing composition, such as at least 0.005 percent by weight metal, such as 0.007 percent by weight metal. The Group IVB metal may be present in the sealing composition in a total amount of no more than 1.5 percent by weight based on total weight of the sealing composition, such as no more than 0.06 percent by weight metal, such as no more than 0.03 percent by weight metal. The Group IVB metal may be present in the sealing composition in a total amount of 0.002 percent by weight metal to 1.5 percent by weight metal based on total weight of the sealing composition, such as from 0.005 percent by weight to 0.06 percent by weight metal, such as from 0.007 percent by weight to 0.3 percent by weight metal. As used herein, the term “total amount,” when used with respect to the amount of Group IVB metal, means the sum of all Group IVB metals present in the sealing composition.

The sealing composition may further comprise a carbonate. The carbonate may be present in an amount of at least 0.01 percent by weight based on total weight of the sealing composition, such as at least 0.05 percent by weight, and may be present in an amount of no more than 0.2 percent by weight based on total weight of the sealing composition, such as no more than 0.15 percent by weight. The carbonate may be present in an amount of 0.01 percent by weight to 0.2 percent by weight based on total weight of the sealing composition, such as 0.05 percent by weight to 0.15 percent by weight. The carbonate excludes zirconium carbonate.

The sealing composition may have a pH of at least 7, such as at least 7.5, and may have a pH of no more than 11, such as no more than 9. The sealing composition may have a pH of 7 to 11, such as 7.5 to 9.

The sealing composition may have a total solids content of at least 0.25 percent by weight based on total weight of the composition, such as at least 1 percent by weight, such as at least 10 percent by weight, and may have a total solids content of no more than 40 percent by weight based on total weight of the composition, such as no more than 30 percent by weight, such as no more than 25 percent by weight. The composition may have a total solids content of 0.25 percent by weight to 40 percent by weight based on total weight of the composition, such as 1 percent by weight to 30 percent by weight, such as 3 percent by weight to 100 percent by weight, such as 10 percent by weight to 50 percent by weight, such as 10 percent by weight to 25 percent by weight. As used herein, “total solids” refers to the non-volatile content of the composition, i.e., materials which will not volatilize when heated to 105° C. and standard atmospheric pressure (101325 Pa) for 60 minutes.

The sealing composition of the present disclosure may have a viscosity of at least 10 cP measured at ambient conditions, e.g., 23° C. and 60% relative humidity, using a Brookfield DV-I Prime Viscometer and a number 1 sized, 5.5 cm diameter spindle completely submerged in the sealing composition and with a shear rate of 81 s⁻¹, such as at least 15 cP, such as at least 25 cP, and may have a viscosity of no more than 500 cP measured at ambient conditions using a Brookfield DV-I Prime Viscometer and a number 1 sized, 5.5 cm diameter spindle completely submerged in the sealing composition and set to a shear rate of 81 s⁻¹, such as no more than 350 cP, such as no more than 150 cP. The sealing composition of the present disclosure may have a viscosity of 10 cP to 500 cP measured at ambient conditions using a Brookfield DV-I Prime Viscometer and a number 1 sized, 5.5 cm diameter spindle completely submerged in the sealing composition and set to a shear rate of 81 s⁻¹, such as at least 15 cP to 350 cP, such as 25 cP to 150 cP.

The sealing composition of the present disclosure may have a viscosity of at least 10 cP measured at ambient conditions using a Brookfield DV-I Prime Viscometer and a number 1 sized, 5.5 cm diameter spindle completely submerged in the sealing composition and set to 100 RPM, such as at least 15 cP, and may have a viscosity of no more than 250 cP measured at ambient conditions using a Brookfield DV-I Prime Viscometer and a number 1 sized, 5.5 cm diameter spindle completely submerged in the sealing composition and set to 100 RPM, such as no more than 150 cP. The sealing composition of the present disclosure may have a viscosity of 10 cP to 250 cP measured at ambient conditions using a Brookfield DV-I Prime Viscometer and a number 1 sized, 5.5 cm diameter spindle completely submerged in the sealing composition and set to 100 RPM, such as at least 15 cP to 120 cP.

The sealing composition may comprise a carrier, often an aqueous medium, so that the composition is in the form of a solution or dispersion of the polyolefin component in the carrier.

### System

As stated above, the present disclosure is also directed to a system for treating a metal substrate comprising: a cleaner composition; and/or a pretreatment composition for treating at least a portion of the substrate, the pretreatment composition comprising a Group IVB metal; and a sealing composition for treating at least a portion of the substrate treated with the cleaner composition and/or the pretreatment composition, the sealing composition comprising a polyolefin component.

### Cleaner Composition

The system of the present disclosure optionally may further comprise a cleaner. At least a portion of the substrate surface may be cleaned prior to contacting at least a portion of the substrate surface with one of the pretreatment compositions described herein below to remove grease, dirt, and/or other extraneous matter. At least a portion of the surface of the substrate may be cleaned by physical and/or chemical means, such as mechanically abrading the surface and/or cleaning/degreasing the surface with commercially available alkaline or acidic cleaning agents that are well known to those skilled in the art. Examples of alkaline cleaners suitable for use include Chemkleen™ 166HP, 166M/C, 177, 490MX, 2010LP, and Surface Prep 1 (SP1), Ultrax 32, Ultrax 97, Ultrax 29, and Ultrax92D, each of which are commercially available from PPG Industries, Inc. (Cleveland, OH), and any of the DFM Series, RECC 1001, and 88X1002 cleaners (commercially available from PRC-DeSoto International, Sylmar, CA), and Turco 4215-NCLT and Ridolene (commercially available from Henkel Technologies, Madison Heights, MI). Examples of acidic cleaners suitable for use include Acid Metal Cleaner (AMC) 23, AMC 239, AMC 240, AMC 533, AMC66AW, and acetic acid. Such cleaners are often preceded and/or followed by a water rinse, such as with tap water, distilled water, or combinations thereof.

Following the cleaning step(s), the substrate optionally may be rinsed with tap water, deionized water, and/or an aqueous solution of rinsing agents to remove any residue. The wet substrate surface may be treated with one of the pretreatment compositions described above or the substrate may be dried prior to treating the substrate surface, such as air dried, for example, by using an air knife, by flashing off the water by brief exposure of the substrate to a high temperature, such as 15° C. to 100° C., such as 20° C. to 90° C., or in a heater assembly using, for example, infrared heat, such as for 10 minutes at 70° C., or by passing the substrate between squeegee rolls.

### Pretreatment Composition

As stated above, the pretreatment composition may comprise, or consist essentially of, or consist of, a Group IVB metal.

The Group IVB metal may comprise zirconium, titanium, hafnium, or combinations thereof. For example, the Group IVB metal used in the pretreatment composition may be a compound of zirconium, titanium, hafnium, or a mixture thereof. Examples of suitable compounds include those that are recited herein above.

The Group IVB metal may be present in the composition in a total amount of at least 20 ppm metal (calculated as metal cation) based on total weight of the pretreatment composition, such as at least 50 ppm metal, or, in some cases, at least 70 ppm metal. The Group IVB metal may be present in the pretreatment composition in a total amount of no more than 1000 ppm metal (calculated as metal cation) based on total weight of the pretreatment composition, such as no more than 600 ppm metal, or, in some cases, no more than 300 ppm metal. The Group IVB metal may be present in the pretreatment composition in a total amount of 20 ppm metal to 1000 ppm metal (calculated as metal cation) based on total weight of the pretreatment composition, such as from 50 ppm metal to 600 ppm metal, such as from 70 ppm metal to 300 ppm metal. As used herein, the term “total amount,” when used with respect to the amount of Group IVB metal, means the sum of all Group IVB metal in the pretreatment composition can range between the recited values inclusive of the recited values.

The pretreatment composition also may comprise a Group IA metal such as lithium. The source of Group IA metal in the pretreatment composition may be in the form of a salt. Non-limiting examples of suitable lithium salts include lithium nitrate, lithium sulfate, lithium fluoride, lithium chloride, lithium hydroxide, lithium carbonate, lithium iodide, and combinations thereof.

The Group IA metal may be present in the pretreatment composition in an amount of at least 2 ppm (as metal cation) based on a total weight of the pretreatment composition, such as at least 5 ppm, such as at least 25 ppm, such as at least 75 ppm, and in some instances, may be present in an amount of no more than 500 ppm (as metal cation) based on a total weight of the pretreatment composition, such as no more than 250 ppm, such as no more than 125 ppm, such as no more than 100 ppm. The Group IA metal may be present in the pretreatment composition in an amount of 2 ppm to 500 ppm (as metal cation) based on a total weight of the pretreatment composition, such as 5 ppm to 250 ppm, such as 5 ppm to 125 ppm, such as 5 ppm to 100 ppm, such as 25 ppm to 125 ppm, such as 5 ppm to 100 ppm. The amount of Group IA metal in the pretreatment composition can range between the recited values inclusive of the recited values.

The pretreatment composition may also comprise a Group VIB metal such as molybdenum. The source of Group VIB metal in the pretreatment composition may be in the form of a salt. Non-limiting examples of suitable molybdenum salts include sodium molybdate, lithium molybdate, calcium molybdate, potassium molybdate, ammonium molybdate, molybdenum chloride, molybdenum acetate, molybdenum sulfamate, molybdenum formate, molybdenum lactate, and combinations thereof.

The Group VIB metal may be present in the pretreatment composition in an amount of at least 5 ppm (as metal cation) based on a total weight of the pretreatment composition, such as at least 25 ppm, such as at least 100 ppm, and in some instances, may be present in the composition in an amount of no more than 500 ppm (as metal cation) based on total weight of the pretreatment composition, such as no more than 250 ppm, such as no more than 150 ppm. The Group VIB metal may be present in the pretreatment composition in an amount of 5 ppm to 500 ppm (as metal cation) based on total weight of the pretreatment composition, such as 25 ppm to 250 ppm, such as 100 ppm to 150 ppm. The amount of Group VIB metal in the pretreatment composition can range between the recited values inclusive of the recited values.

The pretreatment composition may further comprise an anion that may be suitable for forming a salt with the pretreatment composition metal cations, such as a halogen, a nitrate, a sulfate, a silicate (orthosilicates and metasilicates), carbonates, hydroxides, and the like.

The pretreatment composition also may comprise an electropositive metal ion. As used herein, the term “electropositive metal ion” refers to metal ions that will be reduced by the metal substrate being treated when the pretreatment solution contacts the surface of the metallic substrate. As will be appreciated by one skilled in the art, the tendency of chemical species to be reduced is called the reduction potential, is expressed in volts, and is measured relative to the standard hydrogen electrode, which is arbitrarily assigned a reduction potential of zero. The reduction potential for several elements is set forth in Table 1 below (according to the CRC 82^{nd} Edition, 2001-2002). An element or ion is more easily reduced than another element or ion if it has a voltage value, E*, in the following table, that is more positive than the elements or ions to which it is being compared.

TABLE 1

| Element | Reduction half-cell reaction | Voltage, E* |
|---|---|---|
| Potassium | K⁺ + e → K | −2.93 |
| Calcium | Ca²⁺ + 2e → Ca | −2.87 |
| Sodium | Na⁺ + e → Na | −2.71 |
| Magnesium | Mg²⁺ + 2e → Mg | −2.37 |
| Aluminum | Al³⁺ + 3e → Al | −1.66 |
| Zinc | Zn²⁺ + 2e → Zn | −0.76 |
| Iron | Fe²⁺ + 2e → Fe | −0.45 |
| Nickel | Ni²⁺ + 2e → Ni | −0.26 |
| Tin | Sn²⁺ + 2e → Sn | −0.14 |
| Lead | Pb²⁺ + 2e → Pb | −0.13 |
| Hydrogen | 2H⁺ + 2e → H₂ | −0.00 |
| Copper | Cu²⁺ + 2e → Cu | 0.34 |
| Mercury | Hg₂²⁺ + 2e → 2Hg | 0.80 |
| Silver | Ag⁺ + e → Ag | 0.80 |
| Gold | Au³⁺ + 3e → Au | 1.50 |

Thus, as will be apparent, when the metal substrate comprises one of the following materials, such as cold rolled steel, hot rolled steel, steel coated with zinc metal, zinc compounds, or zinc alloys, hot-dipped galvanized steel, galvannealed steel, steel plated with zinc alloy, aluminum alloys, aluminum plated steel, aluminum alloy plated steel, magnesium and magnesium alloys, suitable electropositive metal ions for deposition thereon include, for example, nickel, copper, silver, and gold, as well as mixtures thereof.

When the electropositive metal ion comprises copper, both soluble and insoluble compounds may serve as a source of copper ions in the pretreatment compositions. For example, the supplying source of copper ions in the pretreatment composition may be a water-soluble copper compound. Specific examples of such compounds include, but are not limited to, copper sulfate, copper nitrate, copper thiocyanate, disodium copper ethylenediaminetetraacetate tetrahydrate, copper bromide, copper oxide, copper hydroxide, copper chloride, copper fluoride, copper gluconate, copper citrate, copper lauroyl sarcosinate, copper lactate, copper oxalate, copper tartrate, copper malate, copper succinate, copper malonate, copper maleate, copper benzoate, copper salicylate, copper amino acid complexes, copper fumarate, copper glycerophosphate, sodium copper chlorophyllin, copper fluorosilicate, copper fluoroborate and copper iodate, as well as copper salts of carboxylic acids such as in the homologous series formic acid to decanoic acid, and copper salts of polybasic acids in the series oxalic acid to suberic acid.

When copper ions supplied from such a water-soluble copper compound are precipitated as an impurity in the form of copper sulfate, copper oxide, etc., it may be desirable to add a complexing agent that suppresses the precipitation of copper ions, thus stabilizing them as a copper complex in the composition.

The copper compound may be added as a copper complex salt such as K₃Cu(CN)₄ or Cu-EDTA, which can be presently stably in the pretreatment composition on its own, but it is also possible to form a copper complex that can be present stably in the pretreatment composition by combining a complexing agent with a compound that is difficult to solubilize on its own. Examples thereof include a copper cyanide complex formed by a combination of CuCN and KCN or a combination of CuSCN and KSCN or KCN, and a Cu-EDTA complex formed by a combination of CuSO₄ and EDTA·2Na.

The electropositive metal ion may be present in the pretreatment composition in an amount of at least 2 ppm (calculated as metal ion) based on the total weight of the pretreatment composition, such as at least 4 ppm, such as at least 6 ppm, such as at least 8 ppm, such as at least 10 ppm. The electropositive metal ion may be present in the pretreatment composition in an amount of no more than 100 ppm (calculated as metal ion) based on the total weight of the pretreatment composition, such as no more than 80 ppm, such as no more than 60 ppm, such as no more than 40 ppm, such as no more than 20 ppm. The electropositive metal ion may be present in the pretreatment composition in an amount of from 2 ppm to 100 ppm (calculated as metal ion) based on the total weight of the pretreatment composition, such as from 4 ppm to 80 ppm, such as from 6 ppm to 60 ppm, such as from 8 ppm to 40 ppm, such as from 10 ppm to 20 ppm. The amount of electropositive metal ion in the pretreatment composition can range between the recited values inclusive of the recited values.

A source of fluoride may be present in the pretreatment composition. As used herein the amount of fluoride disclosed or reported in the pretreatment composition is referred to as “free fluoride,” as measured in parts per million of fluoride. Free fluoride is defined herein as being able to be measured by a fluoride-selective ion-selective electrode (“ISE”). In addition to free fluoride, a pretreatment may also contain “bound fluoride.” As used herein, “bound fluoride” means fluoride that comprises fluoride anions in solution that are ionically or covalently bound to metal cations or hydrogen ions. The sum of the concentrations of the bound and free fluoride equals the total fluoride, which can be supplied by hydrofluoric acid, as well as alkali metal and ammonium fluorides or hydrogen fluorides. Additionally, the total fluoride in the pretreatment composition may be derived from Group IVB metals present in the pretreatment composition, including, for example, hexafluorozirconic acid or hexafluorotitanic acid. Other complex fluorides, such as H₂SiF₆ or HBF₄, can be added to the pretreatment composition to supply total fluoride. The skilled artisan will understand that the presence of free fluoride in the pretreatment bath can impact pretreatment deposition and etching of the substrate, hence it is critical to measure this bath parameter. The levels of free fluoride will depend on the pH and the addition of chelators into the pretreatment bath and indicates the degree of fluoride association with the metal ions/protons present in the pretreatment bath. For example, pretreatment compositions of identical total fluoride levels can have different free fluoride levels which will be influenced by the pH and chelators present in the pretreatment solution.

The free fluoride of the pretreatment composition may be present in an amount of at least 15 ppm, based on a total weight of the pretreatment composition, such as at least 50 ppm free fluoride, such as at least 100 ppm free fluoride, such as at least 200 ppm free fluoride. The free fluoride of the pretreatment composition may be present in an amount of no more than 2,500 ppm, based on a total weight of the pretreatment composition, such as no more than 1,000 ppm free fluoride, such as no more than 500 ppm free fluoride, such as no more than 250 ppm free fluoride. The free fluoride of the pretreatment composition may be present in an amount of 15 ppm free fluoride to 2,500 ppm free fluoride, based on a total weight of the pretreatment composition, such as 50 ppm free fluoride to 1,000 ppm free fluoride, such as 100 ppm free fluoride to 500 ppm free fluoride, such as 100 ppm free fluoride to 250 ppm free fluoride, such as 200 ppm free fluoride to 500 ppm, such as free fluoride, such as 200 ppm free fluoride to 250 ppm free fluoride. The amount of free fluoride in the pretreatment composition can range between the recited values inclusive of the recited values.

The pretreatment composition may, in some instances, comprise an oxidizing agent. Non-limiting examples of the oxidizing agent include peroxides, persulfates, perchlorates, chlorates, hypochlorite, nitric acid, sparged oxygen, bromates, peroxi-benzoates, ozone, or combinations thereof.

The oxidizing agent may be present, if at all, in an amount of at least 50 ppm based on total weight of the pretreatment composition, such as at least 500 ppm, and in some instances, may be present in an amount of no more than 13,000 ppm based on total weight of the pretreatment composition, such as no more than 3,000 ppm. In some instances, the oxidizing agent may be present in the pretreatment composition, if at all, in an amount of 100 ppm to 13,000 ppm based on total weight of the pretreatment composition, such as 500 ppm to 3,000 ppm. The amount of oxidizing agent in the pretreatment composition can range between the recited values inclusive of the recited values. As used herein, the term “oxidizing agent,” when used with respect to a component of the pretreatment composition, refers to a chemical which is capable of oxidizing at least one of: a metal present in the substrate which is contacted by the pretreatment composition and/or a metal-complexing agent present in the pretreatment composition. As used herein with respect to “oxidizing agent,” the phrase “capable of oxidizing” means capable of removing electrons from an atom or a molecule present in the substrate or the pretreatment composition, as the case may be, thereby decreasing the number of electrons of such atom or molecule.

The pretreatment composition may exclude chromium or chromium-containing compounds. As used herein, the term “chromium-containing compound” refers to materials that include trivalent and/or hexavalent chromium. Non-limiting examples of such materials include chromic acid, sodium dichromate, chromium(III) sulfate, chromium(III) chloride, and chromium(III) nitrate. When a pretreatment composition and/or a coating or a layer, respectively, formed from the same is substantially free, essentially free, or completely free of chromium, this includes chromium in any form, such as, but not limited to, the trivalent and hexavalent chromium-containing compounds listed above.

Thus, optionally, the pretreatment compositions and/or coatings or layers, respectively, deposited from the same may be substantially free, may be essentially free, and/or may be completely free of one or more of any of the elements or compounds listed in the preceding paragraph. A pretreatment composition and/or coating or layer, respectively, formed from the same that is substantially free of chromium or derivatives thereof means that chromium or derivatives thereof are not intentionally added, but may be present in trace amounts, such as because of impurities or unavoidable contamination from the environment. In other words, the amount of material is so small that it does not affect the properties of the pretreatment composition; in the case of chromium, this may further include that the element or compounds thereof are not present in the pretreatment compositions and/or coatings or layers, respectively, formed from the same in such a level that it causes a burden on the environment. The term “substantially free” means that the pretreatment compositions and/or coating or layers, respectively, formed from the same contain less than 10 ppm of any or all of the elements or compounds listed in the preceding paragraph, based on total weight of the composition or the layer, respectively, if any at all. The term “essentially free” means that the pretreatment compositions and/or coatings or layers, respectively, formed from the same contain less than 1 ppm of any or all of the elements or compounds listed in the preceding paragraph, if any at all. The term “completely free” means that the pretreatment compositions and/or coatings or layers, respectively, formed from the same contain less than 1 ppb of any or all of the elements or compounds listed in the preceding paragraph, if any at all.

The pretreatment composition may, in some instances, exclude phosphate ions or phosphate-containing compounds and/or the formation of sludge, such as aluminum phosphate, iron phosphate, and/or zinc phosphate, formed in the case of using a treating agent based on zinc phosphate. As used herein, “phosphate-containing compounds” include compounds containing the element phosphorous such as ortho phosphate, pyrophosphate, metaphosphate, tripolyphosphate, organophosphonates, and the like, and can include, but are not limited to, monovalent, divalent, or trivalent cations such as: sodium, potassium, calcium, zinc, nickel, manganese, aluminum and/or iron. When a composition and/or a layer or coating comprising the same is substantially free, essentially free, or completely free of phosphate, this includes phosphate ions or compounds containing phosphate in any form.

Thus, a pretreatment composition and/or layers deposited from the same may be substantially free, or in some cases may be essentially free, or in some cases may be completely free, of one or more of any of the ions or compounds listed in the preceding paragraph. A pretreatment composition and/or layers deposited from the same that is substantially free of phosphate means that phosphate ions or compounds containing phosphate are not intentionally added, but may be present in trace amounts, such as because of impurities or unavoidable contamination from the environment. In other words, the amount of material is so small that it does not affect the properties of the composition; this may further include that phosphate is not present in the pretreatment compositions and/or layers deposited from the same in such a level that they cause a burden on the environment. The term “substantially free” means that the pretreatment compositions and/or layers deposited from the same contain less than 5 ppm of any or all of the phosphate anions or compounds listed in the preceding paragraph, based on total weight of the composition or the layer, respectively, if any at all. The term “essentially free” means that the pretreatment compositions and/or layers comprising the same contain less than 1 ppm of any or all of the phosphate anions or compounds listed in the preceding paragraph. The term “completely free” means that the pretreatment compositions and/or layers comprising the same contain less than 1 ppb of any or all of the phosphate anions or compounds listed in the preceding paragraph, if any at all.

Alternatively, the pretreatment composition may further comprise a source of phosphate ions. For clarity, when used herein, “phosphate ions” refers to phosphate ions that derive from or originate from inorganic phosphate compounds. For example, in some instances, phosphate ions may be present in an amount of greater than 5 ppm, based on total weight of the pretreatment composition, such as 10 ppm, such as 20 ppm. In some instances, phosphate ions may be present in an amount of no more than 60 ppm, based on total weight of the pretreatment composition, such as no more than 40 ppm, such as no more than 30 ppm. In some instances, phosphate ions may be present in an amount of from 5 ppm to 60 ppm, based on total weight of the pretreatment composition, such as from 10 ppm to 40 ppm, such as from 20 ppm to 30 ppm. The amount of phosphate ions in the pretreatment composition can range between the recited values inclusive of the recited values.

The pH of the pretreatment composition may be 6.5 or less, such as 5.5 or less, such as 4.5 or less, such as 3.5 or less. The pH of the pretreatment composition may, in some instances, be 2.0 to 6.5, such as 3 to 4.5, and may be adjusted using, for example, any acid and/or base as is necessary. The pH of the pretreatment composition may be maintained through the inclusion of an acidic material, including water soluble and/or water dispersible acids, such as nitric acid, sulfuric acid, and/or phosphoric acid. The pH of the composition may be maintained through the inclusion of a basic material, including water soluble and/or water dispersible bases, such as sodium hydroxide, sodium carbonate, potassium hydroxide, ammonium hydroxide, ammonia, and/or amines such as triethylamine, methylethyl amine, or mixtures thereof.

The pretreatment composition also may further comprise a resinous binder. Suitable resins include reaction products of one or more alkanolamines and an epoxy-functional material containing at least two epoxy groups, such as those disclosed in U.S. Pat. No. 5,653,823. In some cases, such resins contain beta hydroxy ester, imide, or sulfide functionality, incorporated by using dimethylolpropionic acid, phthalimide, or mercaptoglycerine as an additional reactant in the preparation of the resin. Alternatively, the reaction product can for instance be that of the diglycidyl ether of Bisphenol A (commercially available, e.g., from Shell Chemical Company as EPON 880), dimethylol propionic acid, and diethanolamine in a 0.6 to 5.0:0.05 to 5.5:1 mole ratio. Other suitable resinous binders include water soluble and water dispersible polyacrylic acids such as those disclosed in U.S. Pat. Nos. 3,912,548 and 5,328,525; phenol formaldehyde resins such as those described in U.S. Pat. No. 5,662,746; water soluble polyamides such as those disclosed in WO 95/33869; copolymers of maleic or acrylic acid with allyl ether such as those described in Canadian patent application 2,087,352; and water soluble and dispersible resins including epoxy resins, aminoplasts, phenol-formaldehyde resins, tannins, and polyvinyl phenols such as those discussed in U.S. Pat. No. 5,449,415.

The resinous binder often may be present in the pretreatment composition in an amount of 0.005 percent to 30 percent by weight, such as 0.5 to 3 percent by weight, based on the total weight of the pretreatment composition. The amount of resinous binder in the pretreatment composition can range between the recited values inclusive of the recited values. Alternatively, the pretreatment composition may be substantially free or, in some cases, completely free, of any resinous binder. As used herein, the term “substantially free”, when used with reference to the absence of resinous binder in the pretreatment composition, means that, if present at all, any resinous binder is present in the pretreatment composition in a trace amount of less than 0.005 percent by weight, based on total weight of the composition. As used herein, the term “completely free” means that there is no resinous binder in the pretreatment composition at all.

The pretreatment composition may comprise an aqueous medium and may optionally contain other materials such as nonionic surfactants and auxiliaries conventionally used in the art of pretreatment compositions. In the aqueous medium, water dispersible organic solvents, for example, alcohols with up to about 8 carbon atoms such as methanol, isopropanol, and the like, may be present; or glycol ethers such as the monoalkyl ethers of ethylene glycol, diethylene glycol, or propylene glycol, and the like. When present, water dispersible organic solvents are typically used in amounts up to about ten percent by volume, based on the total volume of aqueous medium.

Other optional materials include surfactants that function as defoamers or substrate wetting agents. Anionic, cationic, amphoteric, and/or nonionic surfactants may be used. Defoaming surfactants may optionally be present at levels up to 1 weight percent, such as up to 0.1 percent by weight, and wetting agents are typically present at levels up to 2 percent, such as up to 0.5 percent by weight, based on the total weight of the pretreatment composition.

The pretreatment composition may comprise a carrier, often an aqueous medium, so that the composition is in the form of a solution or dispersion of the Group IVB metal in the carrier. The solution or dispersion may be brought into contact with the substrate by any of a variety of known techniques, such as dipping or immersion, spraying, intermittent spraying, dipping followed by spraying, spraying followed by dipping, brushing, or roll-coating. The solution or dispersion when applied to the metal substrate is at a temperature ranging from 40° F. to 185° F., such as 60° F. to 110° F., such as 70° F. to 90° F. For example, the pretreatment process may be carried out at ambient or room temperature. The contact time is often from 5 seconds to 15 minutes, such as 10 seconds to 10 minutes, such as 15 seconds to 3 minutes.

Following the contacting with the pretreatment composition, the substrate may be rinsed with tap water, deionized water, and/or an aqueous solution of rinsing agents to remove any residue. The substrate optionally may be air dried at room temperature or may be dried with hot air, for example, by using an air knife, by flashing off the water by brief exposure of the substrate to a high temperature, such as by drying the substrate in an oven at 15° C. to 200° C., such as 20° C. to 90° C., or in a heater assembly using, for example, infrared heat, such as for 10 minutes at 70° C., or by passing the substrate between squeegee rolls. Following the contacting with the pretreatment composition, the substrate optionally may be rinsed with tap water, deionized water, and/or an aqueous solution of rinsing agents to remove any residue and then optionally may be dried, for example air dried or dried with hot air as described in the preceding sentence.

The thickness of the pretreatment coating may for instance be equal to or less than 1 micrometer, for example from 1 to 1000 nanometers, or from 20 to 500 nanometers.

### Method

As noted above, the present disclosure is also directed to a method of treating a substrate, comprising contacting at least a portion of a surface of the substrate with any of the sealing compositions or systems described herein. Also disclosed herein is a method of treating a substrate comprising passing electric current between a cathode and the substrate, serving as an anode, said cathode and anode being immersed in a sealing composition comprising a polyolefin component.

According to the present disclosure, the sealing composition may be spontaneously applied to a surface of a substrate. For example, the sealing composition may be brought into contact with a substrate by any of a variety of known techniques, such as dipping or immersion, spraying, intermittent spraying, dipping followed by spraying, spraying followed by dipping, brushing, or roll-coating. The solution or dispersion when applied to the metal substrate may be at a temperature ranging from 40° F. to 185° F., such as 60° F. to 110° F., such as 70° F. to 90° F. For example, treatment of a substrate with the sealing composition of the present disclosure may be carried out at ambient or room temperature. The contact time may be less than 1 second to 15 minutes, such as 5 seconds to 15 minutes, such as 10 seconds to 10 minutes, such as 15 seconds to 3 minutes.

In other examples, the sealing composition may be electrodeposited on a surface of a substrate. The present disclosure also is directed to a method of treating a substrate comprising: passing electric current between a cathode and the substrate, serving as an anode, the cathode and anode being immersed in one of the sealing compositions described above to deposit a coating from the electrodepositable sealing composition onto a surface of the substrate. In the process of electrodeposition, a cathode and the metal substrate being treated, serving as an anode, may be placed in the electrodepositable sealing composition. Upon passage of an electric current between the cathode and the anode while they are in contact with the electrodepositable sealing composition, a layer may form on the surface of the substrate from the electrodepositable sealing composition. Sufficient electrical current may be applied between the electrodes to deposit a film of the electrodepositable pretreatment coating composition onto or over at least a portion of the surface of the electroconductive substrate, e.g., covering at least 75% of the substrate surface which was immersed in the electrodepositable sealing composition, such as at least 85% of the substrate surface, such as at least 95% of the substrate surface. It should be understood that as used herein, an electrodepositable sealing composition or coating formed “over” at least a portion of a “substrate” refers to a composition formed directly on at least a portion of the substrate surface, as well as a composition or coating formed over any coating or pretreatment material which was previously applied to at least a portion of the substrate. According to the present disclosure, the electrodeposition is usually carried out at a current density of from 0.5 mAmps/cm² of substrate to 50 mAmps/cm² of substrate, such as from 1 mAmps/cm² of substrate to 20 mAmps/cm² of substrate, such as from 2 mAmps/cm² of substrate to 10 mAmps/cm² of substrate. One skilled in the art of electrodeposition will understand the amperage and voltage requirements necessary to achieve the disclosed range of current density. The electrodepositable sealing composition may be applied under a constantly applied power. Alternatively, according to the present disclosure, the electrodepositable sealing composition may be applied with a pulsing power. As used herein with respect to application of the electrodepositable sealing composition, “pulsing” means cycling between a “current on” and a “current off” condition at a range of frequencies known to one of ordinary skill in the art of electrodeposition.

Following the contacting with the sealing composition, the substrate may be rinsed with tap water, deionized water, and/or an aqueous solution of rinsing agents in order to remove any residue. The substrate optionally may be air dried at room temperature or may be dried with hot air, for example, by using an air knife, by flashing off the water by brief exposure of the substrate to a high temperature, such as by drying the substrate in an oven at 15° C. to 200° C., such as 20° C. to 90° C., or in a heater assembly using, for example, infrared heat, such as for 10 minutes at 70° C., or by passing the substrate between squeegee rolls.

The metal substrate to be treated in accordance with the methods of the present disclosure may first be cleaned to remove grease, dirt, and/or other extraneous matter.

For example, at least a portion of the surface of the substrate may be cleaned by physical and/or chemical means, such as mechanically abrading the surface and/or cleaning/degreasing the surface with any of the cleaning compositions disclosed herein above.

Following the cleaning step(s), the substrate optionally may be rinsed with tap water, deionized water, and/or an aqueous solution of rinsing steps to remove any residue. The wet substrate surface may be treated with one of the sealing compositions described above or the substrate may be dried as described above prior to treating the substrate surface.

According to the present disclosure, at least a portion of the cleaned substrate surface may be deoxidized, mechanically and/or chemically. As used herein, the term “deoxidize” means removal of the oxide layer found on the surface of the substrate to promote uniform deposition of the pretreatment composition (described below), as well as to promote the adhesion of the pretreatment composition coating to the substrate surface. Suitable deoxidizers will be familiar to those skilled in the art. A typical mechanical deoxidizer may be uniform roughening of the substrate surface, such as by using a scouring or cleaning pad. Typical chemical deoxidizers include, for example, acid-based deoxidizers such as phosphoric acid, nitric acid, fluoroboric acid, sulfuric acid, chromic acid, hydrofluoric acid, and ammonium bifluoride, or Amchem 7/17 deoxidizers (available from Henkel Technologies, Madison Heights, MI), OAKITE DEOXIDIZER LNC (commercially available from Chemetall), TURCO DEOXIDIZER 6 (commercially available from Henkel), or combinations thereof. Often, the chemical deoxidizer comprises a carrier, often an aqueous medium, so that the deoxidizer may be in the form of a solution or dispersion in the carrier, in which case the solution or dispersion may be brought into contact with the substrate by any of a variety of known techniques, such as dipping or immersion, spraying, intermittent spraying, dipping followed by spraying, spraying followed by dipping, brushing, or roll-coating. According to the present disclosure, the skilled artisan will select a temperature range of the solution or dispersion, when applied to the metal substrate, based on etch rates, for example, at a temperature ranging from 50° F. to 150° F. (10° C. to 66° C.), such as from 70° F. to 130° F. (21° C. to 54° C.), such as from 80° F. to 120° F. (27° C. to 49° C.). The contact time may be from 30 seconds to 20 minutes, such as 1 minute to 15 minutes, such as 90 seconds to 12 minutes, such as 3 minutes to 9 minutes.

Following the deoxidizing step, the substrate optionally may be rinsed with tap water, deionized water, or an aqueous solution of rinsing agents, and optionally may be dried as described above.

### Substrate

Further disclosed herein is a substrate comprising a surface treated with any of the sealing compositions, systems, or methods described herein. The present disclosure includes substrates that comprise a film or a coating comprising a polyolefin component. Such a film may be formed from a sealing composition of the present disclosure, and such composition may be applied by spontaneous deposition or electrodeposition, as described above.

Suitable substrates that may be used include metal substrates, metal alloy substrates, and/or substrates that have been metallized, such as nickel-plated plastic. The metal or metal alloy can comprise or be steel, aluminum, zinc, nickel, and/or magnesium. For example, the steel substrate could be cold rolled steel, hot rolled steel, electrogalvanized steel, and/or hot dipped galvanized steel. Aluminum alloys of the 1XXX, 2XXX, 3XXX, 4XXX, 5XXX, 6XXX, or 7XXX series as well as clad aluminum alloys also may be used as the substrate. Aluminum alloys may comprise, for example, 0.01% by weight copper to 10% by weight copper. Aluminum alloys may comprise, for example, 0.01% by weight copper to 10% by weight copper. Aluminum alloys which are treated may also include castings, such as 1XX.X, 2XX.X, 3XX.X, 4XX.X, 5XX.X, 6XX.X, 7XX.X, 8XX.X, or 9XX.X (e.g., A356.0). Magnesium alloys of the AZ31B, AZ91C, AM60B, or EV31A series also may be used as the substrate. The substrate used may also comprise titanium and/or titanium alloys, zinc and/or zinc alloys, and/or nickel and/or nickel alloys. The substrate may comprise a portion of a vehicle such as a vehicular body (e.g., without limitation, door, body panel, trunk deck lid, roof panel, hood roof and/or stringers, rivets, landing gear components, and/or skins used on an aircraft) and/or a vehicular frame. As used herein, “vehicle” or variations thereof includes, but is not limited to, civilian, commercial, and military aircraft, and/or land vehicles such as cars, motorcycles, and/or trucks. The substrate also may comprise an appliance, a personal electronic, a heat exchanger, and the like and/or portions or components thereof.

It has been surprisingly discovered that the colloidal layered silicate and/or rheology modifier, when included in the sealing compositions of the present disclosure, may result in a thickened composition with shear thinning rheological properties. As a result, substrates treated with a composition of the present disclosure may demonstrate improved flow behavior resulting in less pull away of the formed coating from the edges of the substrate, i.e., “picture framing,” and visibly more even film build from the edges of the substrate surface across the substrate surface, i.e., fewer “fat edges.”

It also has been surprisingly discovered that substrates spontaneously treated with a sealing composition of the present disclosure having a viscosity of 10 cP to 500 cP measured using a Brookfield DV-I Prime Viscometer and a number 1 sized, 5.5 cm diameter spindle completely submerged in the sealing composition and set to a shear rate of 81 s⁻¹ and a total solids content of 0.25 percent by weight to 40 percent by weight based on total weight of the composition results in a film formed on the surface of the treated substrate of at least 0.03 mil (dry film thickness, “DFT”), such as at least 0.04 mil, such as at least 0.05 mil, such as at least 0.1 mil, such as at least 0.2 mil, such as at least 0.3 mil, such as at least 0.4 mil and a corrosion rating of at least 4 (rated visually as described in the Examples below) following G-85 A3 cyclic corrosion testing for 7 days. Rheology modifications may be made by adjusting sealing composition solids, by including organic additives such as but not limited to additional polyolefins, and/or by including inorganic additives such as but not limited to colloidal layered dispersions. Additionally, the inclusion of Group IVB metal-containing compounds may also maintain and/or improve corrosion performance (measured as described herein) at lower sealing composition viscosity.

It has also been surprisingly discovered that substrates treated with an electrodeposited sealing composition of the present disclosure results in thicker coatings (as compared to spontaneously applied compositions having the same viscosity) regardless of the rheology of the sealing composition, such as at least 0.1 mil DFT, such as at least 0.2 mil, such as at least 0.3 mil, such as at least 0.4 mil, such as at least 0.5 mil, such as at least 0.6 mil, such as at least 0.7 mil, such as at least 0.8 mil, while having improved corrosion performance as demonstrated by a corrosion rating of at least 4 (rated visually as described in the Examples below), such as 5, following G-85 A3 cyclic corrosion testing for 7 days and capable of receiving 100 double acetone rubs (as described in the Examples) without exposing substrate, such as demonstrating a film loss of less than 70%, such as less than 60%, such as less than 50%, such as less than 40%, such as less than 30%, such as less than 20%, such as less than 10%.

Treatment of a substrate with one of the systems of the present disclosure described herein provided at least one of the following unexpected results, each measured as described in the Examples herein:
(a) a water contact angle of at least 80° measured according to ASTM D7334-08;
(b) a barrier property of at least 1E⁴ ohm·cm² as measured using electrochemical impedance spectroscopy conducted in quiescent 5 wt % NaCl solution after 30 minutes at open circuit potential using a Gamfry Reference 600+ potentiostat in sine mode from 100 Hz to 0.01 Hz with 6 points per decade on an AC amplitude of 20 mV;
(c) a corrosion rating of at least 4 (according to rating scale described in the Examples) following 48 hr exposure to salt spray and/or 168 hr testing according to G-85A3;
(d) a ΔL of at least 0.01 and up to 0.5 following weathering test according to D4587;
(e) a wet adhesion of 5B measured according to the crosshatch adhesion test;
(f) a pit density of no more than 3 pit/cm² measured using a Keyence VR3200 3D Measuring Macroscope (surface topologies of 8.4 cm×7.6 cm at a pixel resolution of 11.8 μm);
(g) a pit depth of no more than 500 μm measured using a Keyence VR3200 3D Measuring Macroscope (surface topologies of 8.4 cm×7.6 cm at a pixel resolution of 11.8 μm); and/or
(h) a film thickness of at least 0.04 mil measured using a Fischerscope MMS device purchased from Fischer Technology Inc.

### EXAMPLES

Preparation of Cleaners, Pretreatment Compositions, and Sealing Compositions

Preparation of alkaline cleaner I (AC-I): A rectangular stainless-steel tank with a total volume of 37 gallons, equipped with spray nozzles, was filled with 10 gallons of deionized water. To this was added 500 mL of Chemkleen 2010LP (a phosphate-free alkaline cleaner available from PPG Industries, Inc.) and 50 mL of Chemkleen 181ALP (a phosphate-free blended surfactant additive available from PPG Industries, Inc.). Alkaline cleaner I was used in each of the Examples.

Preparation of Pretreatment Composition A (PT-A): To a clean five-gallon plastic bucket was added 18.9 liters of deionized water. 19.13 g of fluorozirconic acid (19.13 g) (45 wt. % in water; available from Honeywell International, Inc. (Morristown, NJ)) was added. The material was circulated using an immersion heater set to 80° F. The pH was measured using a pH meter (interface, DualStar pH/ISE Dual Channel Benchtop Meter, available from ThermoFisher Scientific, Waltham, Massachusetts, USA; pH probe, Fisher Scientific Accumet pH probe (Ag/AgCl reference electrode)) by immersing the pH probe in the pretreatment solution. Free fluoride was measured using a DualStar pH/ISE Dual Channel Benchtop Meter (ThermoFisher Scientific) equipped with a fluoride selective electrode (Orion ISE Fluoride Electrode, solid state, available from ThermoFisher Scientific) by immersing the ISE in the pretreatment solution and allowing the measurement to equilibrate. Then, the pH was adjusted as needed to a pH range of 4.6 to 4.8 with 31.6 g Chemfil buffer (an alkaline buffering solution, commercially available from PPG Industries, Inc.). The free fluoride was adjusted as needed to range of 25 to 150 ppm with 13.7 g Chemfos AFL (a partially neutralized aqueous ammonium bifluoride solution, commercially available from PPG Industries, Inc. and prepared according to supplier instructions).

Preparation of a Comparative Pretreatment: Bonderite 1455 (a titanium-containing pretreatment composition commercially available from Henkel Corp.) used according to manufacturer specifications.

Preparation of a Colloidal Layered Silicate Dispersion Composition (CCD): To a clean one-gallon plastic bucket was added 3500 grams of deionized water. The deionized water was placed on agitation (Fawcett Air Motor, Model 103A) at 500 RPM. 70 grams of Laponite RD (commercially available from BYK Additives Inc.) was added over a period of one minute. The dispersion was allowed to mix at ambient conditions for 2 hours.

### Preparation of Sealing Compositions

Sealing Composition 1 (SC-1): SC-1 was prepared by placing 760.00 g of PRIMACOR 5980i (an ethylene acrylic acid copolymer available from Dow Chemical) into a rectangular container without agitation.
Sealing Composition 2 (SC-2): A dispersion was made by charging PRIMACOR 5980i (760.00 g) to a 5-liter, four-neck round bottom flask equipped with a stirrer, water-cooled reflux condenser, and a thermocouple. Dimethylethanol amine (94.04 g), Butyl Cellosolve (19.00 g), and deionized water (2926.96 g) were then charged to the flask. Subsequently the mixture was slowly heated to 92° C. The mixture was held at 92° C. for three hours, at which time the solution was cooled to less than 60° C. and filtered through a 5-micron filter bag into a suitable container. The final dispersion had a solids content of 20 wt %. Next, 78.3 g of the dispersion described above was added to 0.3 liters of water. The material was agitated to ensure adequate mixing. The sealing composition was placed into a rectangular container without agitation when the material was applied to the pretreated panels.
Sealing Composition 3 (SC-3): A sealing composition was prepared according to the following procedure using ingredients listed in Table 2. Ingredients 1, 3, and 4 were combined and set up under nitrogen and the batch was stirred at 300 RPM. Ingredient 2 was then added over 5 minutes. The batch was then heated to 85° C. and stirring was maintained at 300 RPM. The batch was held at 85° C. for 30 minutes followed by a 3 hour hold at 92° C. The batch was then cooled to below 60° C. and filtered through a five-micron filter bag. The final dispersion was 20% solids. An 8 oz. cup with a diameter of 7.3 cm was filled with the sealing composition and viscosity was measured using a Brookfield DV-I Prime Viscometer and a number 1 sized, 5.5 cm diameter spindle. The spindle was completely submerged in the sealing composition and set to 100 RPM. The viscosity was measured to be 115 cP.

TABLE 2
Preparation of Sealing Composition 3 (SC-3)

| Ingredient # | Description | Amount (g) |
|---|---|---|
| 1 | Primacor 5980i¹ | 810.68 |
| 2 | Dimethyl Ethanolamine | 100.28 |
| 3 | Butyl Cellosolve² | 20.27 |
| 4 | Deionized Water | 3122.15 |

¹Available from The Dow Chemical Company
²Available from The Dow Chemical Company

Sealing Composition 4 (SC-4): SC-4 was prepared according to the following procedure using ingredients listed in Table 3. Ingredient 1 was stirred at 100 RPM while ingredient 2 was slowly added over 1 minute. The mixture was then allowed to mix for one hour. The final dispersion was 5% solids. An 8 oz. cup with a diameter of 7.3 cm was filled with the sealing composition and viscosity was measured using a Brookfield DV-I Prime Viscometer and a number 1 sized, 5.5 cm diameter spindle. The spindle was completely submerged in the sealing composition and set to 100 RPM. The viscosity was measured to be 16 cP.

TABLE 3
Preparation of Sealing Composition 4 (SC-4)

| Ingredient # | Description | Amount (g) |
|---|---|---|
| 1 | Sealing Composition (SC-3) | 200 |
| 2 | Deionized Water | 600 |

Sealing Composition 5 (SC-5): SC-5 was prepared according to the following procedure using ingredients listed in Table 4. Ingredient 1 was stirred at 100 RPM while ingredient 2 was slowly added over 1 minute. Ingredient 3 was slowly added to the mixture over 5 minutes. The stirring was increased 350 RPM and the mixture was then allowed to mix for one hour. The final dispersion was 3% solids. An 8 oz. cup with a diameter of 7.3 cm was filled with the sealing composition and viscosity was measured using a Brookfield DV-I Prime Viscometer and a number 1 sized, 5.5 cm diameter spindle. The spindle was completely submerged in the sealing composition and set to 20 RPM. The viscosity was measured to be 380 cP.

TABLE 4
Preparation of Sealing Composition 5 (SC-5)

| Ingredient # | Description | Amount (g) |
|---|---|---|
| 1 | Sealing Composition (SC-1) | 275 |
| 2 | Deionized Water | 1740 |
| 3 | Acrysol TT-615¹ | 20 |

¹Available from The Dow Chemical Company

Sealing Composition 6 (SC-6): SC-6 was prepared according to the following procedure using ingredients listed in Table 5. Ingredients 1, 3, and 4 were combined and set up under nitrogen and the batch was stirred at 300 RPM. Ingredient 2 was then added over 5 minutes. The batch was then heated to 85° C. and stirring was maintained at 300 RPM. The batch was held at 85° C. for 30 minutes followed by a 3 hour hold at 92° C. The batch was then cooled to below 60° C. and filtered through a five-micron filter bag. The final dispersion was 20% solids. An 8 oz. cup with a diameter of 7.3 cm was filled with the sealing composition and viscosity was measured using a Brookfield DV-I Prime Viscometer and a number 1 sized, 5.5 cm diameter spindle. The spindle was completely submerged in the sealing composition. The viscosity was measured to be 115 cP at a shear rate of 81 s⁻¹.

TABLE 5
Sealing Composition 6 (SC-6)

| Ingredient # | Description | Amount (g) |
|---|---|---|
| 1 | Primacor 5980i¹ | 811 |
| 2 | Dimethyl Ethanolamine | 100.2 |
| 3 | Butyl Cellosolve² | 27.3 |
| 4 | Deionized Water | 3122.5 |

¹A polyolefin dispersion available from The Dow Chemical Company
²A glycol ether (solvent) available from The Dow Chemical Company

Sealing Composition 7 (SC-7): SC-7 was prepared according to the following procedure using ingredients listed in Table 6. Ingredient 1 was stirred at 100 RPM while ingredient 2 was slowly added over 1 minute. The mixture was then allowed to mix for one hour. The final dispersion was 5% solids and had a viscosity of 16.2 cP as measured by a Brookfield viscometer at a shear rate of 81 s⁻¹ as described above with respect to SC-6.

TABLE 6
Sealing Composition 7 (SC-7)

| Ingredient # | Description | Amount (g) |
|---|---|---|
| 1 | Sealing Composition (SC-6) | 200 |
| 2 | Deionized Water | 600 |

Sealing Composition 8 (SC-8): SC-8 was prepared according to the following procedure using ingredients listed in Table 7. Ingredient 1 was stirred at 100 RPM while ingredient 2 was slowly added over 1 minute. Ingredient 3 was slowly added to the mixture over 5 minutes. The stirring was increased to 350 RPM and the mixture was then allowed to mix for one hour. The final dispersion was 3% solids and had a viscosity of 380 cP as measured by a Brookfield viscometer at a shear rate of 16 s⁻¹ as described above with respect to SC-6.

TABLE 7
Sealing Composition 8 (SC-8)

| Ingredient # | Description | Amount (g) |
|---|---|---|
| 1 | Sealing Composition (SC-6) | 275 |
| 2 | Deionized Water | 1740 |
| 3 | Acrysol TT-615¹ | 20 |

¹A polyolefin-containing material available from The Dow Chemical Company

Sealing Composition 9 (SC-9): SC-9 was prepared according to the following procedure using ingredients listed in Table 8. Ingredient 1 was stirred at 100 RPM while ingredient 2 was slowly added over 1 minute. Ingredient 3 was slowly added to the mixture over 5 minutes. The stirring was increased 350 RPM and the mixture was then allowed to mix for one hour. The final dispersion was 5% solids and had a viscosity of 41 cP as measured by a Brookfield viscometer at a shear rate of 81 s⁻¹ as described above with respect to SC-6.

TABLE 8
Sealing Composition 9 (SC-9)

| Ingredient # | Description | Amount (g) |
|---|---|---|
| 1 | Sealing Composition (SC-6) | 208.4 |
| 2 | Deionized Water | 375 |
| 3 | Colloidal Layered Silicate Dispersion | 416.4 |
| | (CCD) | |

Sealing Composition 10 (SC-10): SC-10 was prepared according to the following procedure using ingredients listed in Table 9. 40.5 grams of ingredient 2 was added to ingredient 4. In a separate container ingredient 1 was stirred at 100 RPM while Ingredient 2 was slowly added over 1 minute. Ingredient 3 was slowly added to the mixture over 5 minutes. Next the dilute solution of ingredient 4 was slowly added to the mixture. The stirring was increased to 350 RPM and the mixture was then allowed to mix for one hour. The final dispersion was 5% solids and had a viscosity of 30.8 cP as measured by a Brookfield viscometer at a shear rate of 81 s⁻¹ as described above with respect to SC-6.

TABLE 9
Sealing Composition 10 (SC-10)

| Ingredient # | Description | Amount (g) |
|---|---|---|
| 1 | Sealing Composition (SC-6) | 189.8 |
| 2 | Deionized Water | 426.5 |
| 3 | Colloidal Layered Silicate Dispersion | 379.2 |
| | (CCD) | |
| 4 | Bacote 20¹ | 4.5 |

¹Bacote 20 is a solution of stabilized ammonium zirconium carbonate containing anionic hydroxylated zirconium polymers available from Luxfer MEL Technologies.

Sealing Composition 11 (SC-11): SC-11 was prepared according to the following procedure using ingredients listed in Table 10. Ingredient 1 was stirred at 100 RPM while ingredient 2 was slowly added over 1 minute. Ingredient 3 was slowly added to the mixture over 5 minutes. Ingredient 4 was then added to the mixture over one minute. The stirring was increased 350 RPM and the mixture was then allowed to mix for one hour. The final dispersion was 5% solids and had a viscosity of 36 cP as measured by a Brookfield viscometer at a shear rate of 81 s⁻¹ measured as described above with respect to SC-6.

TABLE 10
Sealing Composition 11 (SC-11)

| Ingredient # | Description | Amount (g) |
|---|---|---|
| 1 | Sealing Composition (SC-6) | 189.8 |
| 2 | Deionized Water | 427 |
| 3 | Colloidal Layered Silicate Dispersion | 379.2 |
| | (CCD) | |
| 4 | Zirconium Silicate¹ | 4.5 |

¹Available from Sigma-Aldrich.

Sealing Composition 12 (SC-12): SC-12 was prepared according to the following procedure using ingredients listed in Table 11. Ingredient 1 was stirred at 100 RPM while ingredient 2 was slowly added over 1 minute. Ingredient 3 was slowly added to the mixture over 5 minutes. Ingredient 4 was then added to the mixture over one minute. The stirring was increased to 350 RPM and the mixture was then allowed to mix for one hour. The final dispersion was 5% solids and had a viscosity of 14 cP as measured by a Brookfield viscometer at a shear rate of 81 s⁻¹ measured as described above with respect to SC-6.

TABLE 11
Sealing Composition 12 (SC-12)

| Ingredient # | Description | Amount (g) |
|---|---|---|
| 1 | Sealing Composition (SC-6) | 189.8 |
| 2 | Deionized Water | 427 |
| 3 | Colloidal Layered Silicate Dispersion | 379.2 |
| | (CCD) | |
| 4 | Ammonium Carbonate¹ | 4.5 |

¹Fisher Scientific

Sealing Composition (SC-13): SC-13 was prepared according to the following procedure using ingredients listed in Table 12. 40.5 grams of ingredient 2 was added to ingredient 3. In a separate container ingredient 1 was stirred at 100 RPM and the remaining portion of ingredient 2 was added slowly. The dilute mixture of ingredient 3 was then slowly added to the mixture over one minute. The stirring was increased to 350 RPM and the mixture was then allowed to mix for one hour. The final dispersion was 5% solids and had a viscosity of 13.1 cP as measured by a Brookfield viscometer at a shear rate of 81 s⁻¹ measured as described above with respect to SC-6.

TABLE 12
Sealing Composition 13 (SC-13)

| Ingredient # | Description | Amount (g) |
|---|---|---|
| 1 | Sealing Composition (SC-6) | 227.5 |
| 2 | Deionized Water | 767.5 |
| 3 | Bacote 20¹ | 4.5 |

¹Bacote 20 available from Luxfer MEL Technologies

Sealing Composition 14 (SC-14): SC-14 was prepared according to the following procedure using ingredients listed in Table 13. 40.5 grams of ingredient 2 was added to ingredient 4. In a separate container ingredient 1 was stirred at 100 RPM while the remainder of ingredient 2 was slowly added over 1 minute. Ingredient 3 was slowly added to the mixture over 5 minutes. Next the dilute solution of ingredient 4 was slowly added to the mixture. The stirring was increased to 350 RPM and the mixture was then allowed to mix for one hour. The final dispersion was 5% solids and had a viscosity of 26 cP as measured by a Brookfield viscometer at a shear rate of 81 s⁻¹ measured as described with respect to SC-6.

TABLE 13
Sealing Composition 14 (SC-14)

| Ingredient # | Description | Amount (g) |
|---|---|---|
| 1 | Sealing Composition (SC-6) | 189.8 |
| 2 | Deionized Water | 426.5 |
| 3 | Colloidal Layered Silicate Dispersion | 379.2 |
| | (CCD) | |
| 4 | Tyzor TE¹ | 4.5 |

¹Tyzor TE is a triethanolamine titanium chelate commercially available from Dorf Ketal Chemicals LLC

### Example 1. Corrosion Performance on Aluminum Alloy Panels Treated with Sealing Compositions Applied at Constant Thickness

Substrate was purchased from Q-Lab (Westlake, OH) (A-412, cut only, unpolished) and cut from 4″ by 12″ to 4″ by 6″ using a panel cutter prior to application of the alkaline cleaner.

Panels were treated using either Treatment Method A, B, C, or D outlined in Tables 14-17 below. For panels treated according to Treatment Method A, panels were spray cleaned and degreased for 120 seconds at 10-15 psi in the alkaline cleaner (125° F.) using Vee-jet nozzles and rinsed with deionized water by immersing in a deionized water bath (75° F.) for 30 seconds followed by a deionized water spray rinse using a Melnor Rear-Trigger 7-Pattern nozzle set to shower mode (available from Home Depot). Panels were dried with hot air (140° F.) for 120 seconds using a Hi-Velocity handheld blow-dryer made by Oster® (model number 078302-300-000) on high-setting.

For panels treated according to Treatment Method B, panels were cleaned and rinsed as in Method A, except they were subsequently pretreated by immersion in PT-A for 120 seconds (80° F.), and then were rinsed by a deionized water spray rinse and dried with hot air as described in Treatment Method A.

For panels treated according to Treatment Method C, panels were cleaned, pretreated, and rinsed as in Method B, except that following the drying of the pretreated panels, panels were treated with a sealing composition by pipetting 2-4 mL of sealing composition onto the substrate surface and then drawing down with a size 18 bar, the excess being removed (the “drawdown application”). Panels were placed in an oven (Despatch Model LFD-1-42) at approximately 70% to vertical for 5 min. at 212° F.

For panels treated according to Treatment Method D, panels were cleaned and rinsed as in Method A, except that following the drying of the cleaned panels, panels were treated with a sealing composition using the drawdown application described in Treatment Method C. Panels were placed in the oven as described in Treatment Method C.

TABLE 14
Treatment Method A (Comparative)

| | |
|---|---|
| Step 1A | Alkaline cleaner (120 seconds, 125° F., spray application) |
| Step 2A | Deionized water rinse (30 seconds, 75° F., immersion |
| | application) |
| Step 3A | Deionized water rinse (30 seconds, 75° F., spray application) |
| Step 4A | Hot Air Dry (120 seconds, 140° F.) |

TABLE 15
Treatment Method B (Comparative)

| | |
|---|---|
| Step 1B | Alkaline cleaner (120 seconds, 125° F., spray application) |
| Step 2B | Deionized water rinse (30 seconds, 75° F., immersion |
| | application) |
| Step 3B | Deionized water rinse (30 seconds, 75° F., spray application) |
| Step 4B | Zirconium Pretreatment (120 seconds, 80° F., immersion |
| | application) |
| Step 5B | Deionized water rinse (30 seconds, 75° F., spray application) |
| Step 6B | Hot Air Dry (120 seconds, 140° F.) |

TABLE 16
Treatment Method C

| | |
|---|---|
| Step 1C | Alkaline cleaner (120 seconds, 125° F., spray application) |
| Step 2C | Deionized water rinse (30 seconds, 75° F., immersion |
| | application) |
| Step 3C | Deionized water rinse (30 seconds, 75° F., spray application) |
| Step 4C | Zirconium Pretreatment (120 seconds, 80° F., immersion |
| | application) |
| Step 5C | Deionized water rinse (30 seconds, 75° F., spray application) |
| Step 6C | Hot Air Dry (120 seconds, 140° F.) |
| Step 7C | Sealer Composition (drawdown application with size 18 |
| | drawdown bar) |
| Step 8C | Oven Dry (300 seconds, 212° F.) |

TABLE 17
Treatment Method D

| | |
|---|---|
| Step 1D | Alkaline cleaner (120 seconds, 125° F., spray application) |
| Step 2D | Deionized water rinse (30 seconds, 75° F., immersion |
| | application) |
| Step 3D | Deionized water rinse (30 seconds, 75° F., spray application) |
| Step 4D | Hot Air Dry (120 seconds, 140° F.) |
| Step 5D | Sealer Composition (drawdown application with size 18 |
| | drawdown bar) |
| Step 6D | Oven Dry (300 seconds, 212° F.) |

Panels, run in duplicate per Treatment Method, were exposed as coated without being scribed (i.e., no defect) to G-85 A3 cyclic corrosion test 7 to 21 days or salt spray B117 for 1 to 6 days. Amount of corrosion was rated visually after rinsing panels with DI water and wiping dry on a scale of 1 to 5 (see Table 18).

TABLE 18
Rating description of corrosion panels

| Rating | Visual Observation |
|---|---|
| 1 | Extensive surface and pitting corrosion, very little |
| | unaffected areas |
| 2 | 200 pits plus surface corrosion |
| 3 | 50-200 pits on front of 4″ × 6″ but some areas unaffected |
| 4 | 10-25 pits |
| 5 | Less than 5 pits/corrosion sites on whole 4″ × 6″ panel |

To evaluate barrier properties, electrochemical impedance spectroscopy (EIS) was conducted on the panels with a Gamry Reference 600+ potentiostat. EIS scans were acquired in swept sine mode from 100 kHz to 0.01 Hz with six points per decade at an AC amplitude of 20 mV. A three-electrode setup with a standard Ag/AgCl reference electrode and a platinum mesh counter electrode was utilized. The test was conducted in quiescent 5 wt. % NaCl solution after 30 minutes at open circuit potential. Duplicate measurements were carried out for each test condition. The EIS data were analyzed using ZSimpwin with appropriate conceptual models for circuit fitting.

The contact angle of water was measured with the Kruss DSA 100, using the Owens Wendt-Rabel and Kaelble method to calculate surface energy. The procedure performed followed that outlined in ASTM D7334-08, with two measurements being collected from three drops. A drop volume of 2.0 μl was used. Temperature and humidity at the time of testing were 75° F. and 3%, respectively.

TABLE 19
Water Contact Angle, Electrochemical Barrier Property
and Corrosion Following Corrosion Testing

| | | | | | | Rating of | |
|---|---|---|---|---|---|---|---|
| | | | | | | Corrosion | Rating of |
| | | | | Water | | after 48 | Corrosion |
| | | | | Contact | Barrier | hours | after 168 |
| | | | Treatment | Angle | property | Salt Spray | hours |
| PT | Seal | Bake | Method | (deg) | (Ohm*cm²) | (of 5) | G-85 A3 |
| Bonderite | n/a | 100 C., | | 21.5 | 7.85E03 | 4 | 1 |
| 1455 | | 5 min | | | | (*72 h) | |
| comparative | | | | | | | |
| Clean only | n/a | n/a | A | 96.1 | 3.14E03 | 2 | 2 |
| comparative | | | | | | | |
| n/a | SC-1 | 100 C., | D | 88.7 | 1.59E10 | 5 | 5 |
| | | 5 min | | | | | |
| PT-A | SC-1 | 100 C., | C | 97.3 | 3.13E10 | 5 | 5 |
| | | 5 min | | | | | |
| PT-A | n/a | n/a | B | 76.6 | 9.5E03 | 3 | 2 |

A contact angle of 70-80 was considered to be a surface that is neither hydrophobic nor hydrophilic, a contact angle of less than 70 was considered to be hydrophilic, and a contact angle of greater than 80 was considered to be hydrophobic. These data demonstrated that application of a sealing composition of the present disclosure to a non-pretreated substrate surface or following treatment with a pretreatment composition containing zirconium unexpectedly resulted in a hydrophobic substrate surface that had high barrier properties and improved corrosion resistance compared to either comparative.

### Example 2. Corrosion Performance on Aluminum Alloy Panels Treated with Sealing Compositions Applied By Immersion Process

Substrate was purchased from Q-Lab (A-412, cut only, unpolished) and cut from 4″ by 12″ to 4″ by 6″ using a panel cutter prior to application of the alkaline cleaner. Panels were treated using either Treatment Method A, B, or E outlined in Tables 14, 15, or 20.

For panels treated according to Method E, panels were cleaned, pretreated, and rinsed as in Method B, except that following the drying of the cleaned panels a subsequent step of sealing composition application occurred. In a small rectangular container, panels were submerged horizontally in 200 mL of sealing composition for 30 seconds. Samples were removed and placed in ambient conditions at 70% to vertical for up to three hours, until the film was dry to touch.

TABLE 20
Treatment Method E

| | |
|---|---|
| Step 1E | Alkaline cleaner (120 seconds, 125° F., spray application) |
| Step 2E | Deionized water rinse (30 seconds, 75° F., immersion |
| | application) |
| Step 3E | Deionized water rinse (30 seconds, 75° F., spray application) |
| Step 4E | Zirconium Pretreatment (120 seconds, 80° F., immersion |
| | application) |
| Step 5E | Deionized water rinse (30 seconds, 75° F., spray application) |
| Step 6E | Hot Air Dry (120 seconds, 140° F.) |
| Step 7E | Sealer Composition (30 seconds, 72° F., immersion application) |
| Step 8E | Ambient Air Dry (3 hours, 72° F.) |

Panels, run in duplicate per Treatment Method, were exposed as coated (i.e., no defect) to G-85 A3 cyclic corrosion test 7 to 21 days or salt spray B117 for 1 to 6 days. Amount of corrosion was rated visually after rinsing panels with DI water and wiping dry on a scale of 1 to 5 (see Table 18).

Panels also were tested using the weathering test run according to D4587. Data are reported in Table 21.

The paint adhesion for panels treated according to each of the Treatment Methods was then tested under wet (exposed) conditions. Panels were tested and the average adhesion value is shown in Table 21 for wet (exposed) conditions. For the exposed adhesion test, following topcoat application, the panel was immersed in deionized water (60° C.) for 24 hr, at which time the panels were removed, wiped with a towel to dry, and allowed to sit at ambient temperature for 45 minutes. A razor blade was used to scribe eleven lines parallel and perpendicular to the length of one of the panels. The resultant grid area of the scribed lines was 0.5″×0.5″ to 0.75″×0.75″ square. Wet adhesion was assessed by using 3M's Fiber 898 tape, which was firmly adhered over the scribed grid area by rubbing a tongue depressor over the area multiple times prior to pulling it off. The crosshatch area was evaluated for paint loss on a scale from 0 to 5, with 0 being total paint loss and 5 being no paint loss. An adhesion value of 4 is considered acceptable in the industry. Data are reported in Table 21.

Panels (one panel per treatment Method) also were evaluated using a Keyence VR3200 3D Measuring Macroscope, which uses deflectometry to measure 3D surface topology through a non-contact, optical method. For each panel analyzed, surface topologies measuring 8.4 cm×7.6 cm at a pixel resolution of 11.8 μm were acquired and baseline corrected using the software's built-in waveform removal tool with a strength of 3. Pits were characterized using the software's built-in Volume and Area analysis tool. Using this tool, all pits with a depth of greater than 2 μm were counted and summarized. Data are reported in Table 21.

TABLE 21
Water Contact Angle, Electrochemical Barrier Property, Weathering,
Adhesion, and Corrosion Following Corrosion Testing

| | | | | | | Wet | | Pit | |
|---|---|---|---|---|---|---|---|---|---|
| | | | | | D4587 | Adhesion | Rating of | Density | Pit Depth |
| | | | Water | | Weathering | after | Corrosion | (pit/cm²) | (maximum, |
| | | | Contact | Barrier | from Datacolor | 24 h at 60 C. | after | after | μm) after |
| | Post- | Treatment | Angle | Property | 800 after 1000 | water | 504 hours | 504 hr | 504 hr |
| PT | Rinse | Method | (deg) | (Ohm*cm²) | h(ΔL) | immersion | G-85 A3 | G-85 A3 | G-85 A3 |
| | | A | | 3.28E03 | n/a* | n/a* | N/a | N/a | N/a |
| PT-A | n/a | B | 76.6 | 2.35E04 | n/a* | n/a* | 1 | 7.97 | 1128 |
| PT-A | SC-1 | E | 96.5 | 2.6E06 | 0.02 | 5B | 4 | 0.38 | 48 |
| PT-A | SC-2 | E | 68.0 | 1.34E06 | 0.38 | 5B | 5 | 2.66 | 152 |

*Test parameters require a coating according to specifications.

These data demonstrate that application of a sealing composition of the present disclosure following treatment with a pretreatment composition containing zirconium unexpectedly resulted in a hydrophobic substrate surface that had good weathering (i.e., did not yellow over time), did not have any loss of adhesion, had improved corrosion resistance, and smaller pit depths.

### Example 3. Film Build and Corrosion Performance on Aluminum Alloy Panels Treated with a Sealing Composition

Panels were treated using either Treatment Method F, G, H, I, or J, outlined in Tables 22-26, below. For panels treated according to Treatment Method F, panels were spray cleaned and degreased for 120 seconds at 10-15 psi in the bath containing the alkaline cleaner (125° F.) using Vee-jet nozzles and rinsed with deionized water by immersing in a deionized water bath (75° F.) for 30 seconds followed by a deionized water spray rinse and hot air dry as described in Treatment Method A.

For panels treated according to Treatment Method G, panels were cleaned and rinsed as in Method F, and then panels were pretreated by immersion in PT-A for 120 seconds (80° F.), and then were rinsed by a deionized water spray rinse and dried by hot air as described in Treatment Method A.

For panels treated according to Method H, panels were treated with SC-3. In a 1-liter glass beaker, panels were submerged vertically in 800 mL of sealing composition for 30 seconds. Samples were removed and were then placed in the oven described in Treatment Method C vertically for 5 min at 248° F.

For panels treated according to Method I, panels were submerged vertically for 30 seconds in a 1-liter plastic cup containing 800 mL of SC-4. Samples were removed and were then placed vertically in the oven described in Treatment Method C for 5 min at 248° F.

For panels treated according to Method J, panels were submerged vertically for 30 seconds in a 1-liter plastic cup containing 800 mL of SC-5. Samples were removed and were then placed vertically in the oven described in Treatment Method C for 5 min at 248° F.

TABLE 22
Treatment Method F

| | |
|---|---|
| Step 1F | Alkaline cleaner (120 seconds, 125° F., spray application) |
| Step 2F | Deionized water rinse (30 seconds, 75° F., immersion |
| | application) |
| Step 3F | Deionized water rinse (30 seconds, 75° F., spray application) |
| Step 4F | Hot Air Dry (120 seconds, 140° F.) |

TABLE 23
Treatment Method G

| | |
|---|---|
| Step 1G | Alkaline cleaner (120 seconds, 125° F., spray application) |
| Step 2G | Deionized water rinse (30 seconds, 75° F., immersion |
| | application) |
| Step 3G | Deionized water rinse (30 seconds, 75° F., spray application) |
| Step 4G | Pretreatment A (120 seconds, 80° F., immersion application) |
| Step 5G | Deionized water rinse (30 seconds, 75° F., spray application) |
| Step 6G | Hot Air Dry (120 seconds, 140° F.) |

TABLE 24
Treatment Method H

| | |
|---|---|
| Step 1H | Sealer Composition (30 Seconds, 72° F., immersion application) |
| Step 2H | Oven Dried (5 minutes, 248° F.) |

TABLE 25
Treatment Method I

| | |
|---|---|
| Step 1I | Sealer Composition (30 Seconds, 72° F., immersion application) |
| Step 2I | Oven Dried (5 minutes, 248° F.) |

TABLE 26
Treatment Method J

| | |
|---|---|
| Step 1J | Sealer Composition (30 Seconds, 72° F., immersion application) |
| Step 2J | Oven Dried (5 minutes, 248° F.) |

Treated samples, run in duplicate, were exposed as coated (i.e., no defect) to G-85 A2 cyclic corrosion test 7 days. Amount of corrosion was rated visually after rinsing panels with DI water and wiping dry on a scale of 1 to 5 (see Table 18). Film thickness was measured using a Fischerscope MMS device purchased from Fischer Technology Inc.

TABLE 27
Coating Thickness and Corrosion Performance

| | | | | | | Rating of |
|---|---|---|---|---|---|---|
| | | | Sealing | Sealing | | Corrosion |
| | | | Composition | Composition | Treatment | after |
| Treatment | | Sealing | Bath Solids | Viscosity | Thickness | 168 hours |
| Method | Pretreatment | Composition | (%) | (cP) | (mils) | G-85 A3 |
| F | Clean Only | None | n/a | n/a | 0 | 1 |
| G | PT-A | None | n/a | n/a | <0.02 | 1 |
| H | None | SC-3 | 20 | 115 | 0.45 | 5 |
| I | None | SC-4 | 5 | 16 | 0.05 | 4 |
| J | None | SC-5 | 3 | 380 | 0.30 | 5 |

These data demonstrated the rheological behavior of the sealing composition's ability to impart various coating profiles upon application to the substrate. Higher bath viscosity also resulted in thicker coatings. As shown, rheology modifiers were used to adjust the film thickness based on shear thinning/thickening behaviors. The effect of rheology modifiers was not limited to film thickness but also affected sag resistance and overall coating evenness after immersion application. Furthermore, the corrosion resistance was shown to be improved with thicker coatings.

### Example 4. Film Build and Corrosion Performance on Aluminum Alloy Panels Treated with a Sealing Composition from an Immersion Process

Substrate was purchased from Q-Lab (Westlake, OH) (A-412, cut only, unpolished) and cut from 4″ by 12″ to 4″ by 3″ using a panel cutter prior to application of the alkaline cleaner.

Panels were treated using one of Treatment Methods K to M outlined in Tables 28-30 below. According to Treatment Method K, panels were spray cleaned and degreased for 120 seconds at 10-15 psi in the bath containing the alkaline cleaner (125° F.) using Vee-jet nozzles, were rinsed with deionized water by immersion in a deionized 5-gallon water bath (75° F.) for 30 seconds followed by a spray rinse and drying as described in Treatment Method A. Panels were placed in the oven described in Treatment Method C at approximately 70% to vertical for 5 min at 212° F.

According to Treatment Method L, panels were cleaned and rinsed as in Method K, then panels were pretreated by immersion in PT-A for 120 seconds (80° F.), and then were rinsed and dried as described in Treatment Method A.

According to Treatment Method M, panels were treated with one of sealing compositions SC-6 to SC-9, SC-11, or SC-14. In a 1-liter glass beaker, panels were submerged vertically in 800 mL of SC-6 for 30 seconds or in a 1-liter plastic cup, panels were submerged vertically in 800 mL of one of SC-7 to SC-14. Samples were removed and re-submerged at a steady rate between two to five seconds. Treated panels were then placed vertically in the oven described in Treatment Method C for 5 min at 248° F.

TABLE 28
Treatment Method K

| | |
|---|---|
| Step 1K | Alkaline cleaner (120 seconds, 125° F., spray application) |
| Step 2K | Deionized water rinse (30 seconds, 75° F., immersion |
| | application) |
| Step 3K | Deionized water rinse (30 seconds, 75° F., spray application) |
| Step 4K | Hot Air Dry (120 seconds, 140° F.) |

TABLE 29
Treatment Method L

| | |
|---|---|
| Step 1L | Alkaline cleaner (120 seconds, 125° F., spray application) |
| Step 2L | Deionized water rinse (30 seconds, 75° F., immersion |
| | application) |
| Step 3L | Deionized water rinse (30 seconds, 75° F., spray application) |
| Step 4L | Pretreatment A (120 seconds, 80° F., immersion application) |
| Step 5L | Deionized water rinse (30 seconds, 75° F., spray application) |
| Step 6L | Hot Air Dry (120 seconds, 140° F.) |

TABLE 30
Treatment Method M

| | |
|---|---|
| Step 1M | Alkaline cleaner (120 seconds, 125° F., spray application) |
| Step 2M | Deionized water rinse (30 seconds, 75° F., immersion |
| | application) |
| Step 3M | Deionized water rinse (30 seconds, 75° F., spray application) |
| Step 4M | One of SC-6 to SC-14 (30 Seconds, 72° F., immersion |
| | application) |
| Step 5M | Oven Dried (5 minutes, 248° F.) |

Treated samples, run in duplicate per Treatment Method, were exposed as coated (i.e., no defect) to G-85 A3 cyclic corrosion test for 7 days. The amount of corrosion was rated visually on a scale of 1 to 5 outlined in Table 18 above after rinsing panels with DI water and wiping dry. Data reported in Table 31 are an average of the two panels treated per Treatment Method.

TABLE 31
Compositions and Corrosion Performance of Panels Treated in Example 4

| | | | | | | Visual Rating |
|---|---|---|---|---|---|---|
| | | | | | Film | following 7 day |
| reatment | | Sealer | | Viscosity | Build | G85 |
| Method | Pretreatment | Composition | Solids | (cP) | (mil) | Corrosion Testing |
| K | AC-1 | none | n/a | n/a | n/a | 1 |
| L | PT-A | none | n/a | n/a | n/a | 1 |
| M | None | SC-6 | 20% | 115 | 0.45 | 5 |
| M | None | SC-7 | 5% | 16.2 | 0.05 | 4 |
| M | None | SC-8 | 3% | 380 | 0.3 | 5 |
| M | None | SC-9 | 5% | 41 | 0.07 | 5 |
| M | None | SC-11 | 5% | 36 | 0.08 | 5 |
| M | None | SC-14 | 5% | 26 | 0.07 | 5 |

The data in Table 31 demonstrate that corrosion performance can be improved by adjusting the rheology of the sealing composition. This can be seen by comparing corrosion performance and film build with sealing composition viscosity. Despite SC-8, SC-9, SC-11, and SC-14 having the same or lower solids content than SC-7, they provided thicker coatings and increased viscosity. Rheology modifications resulted in thicker coatings, more even coatings, fewer “fat edges,” and/or a coating that is less prone to “picture-framing” (i.e., pulling away from edges that is visible to the naked eye). The data from Example 4 demonstrate that rheology modifications may be made by adjusting sealing composition solids, by including organic additives such as but not limited to additional polyolefins, and/or by including inorganic additives such as but not limited to colloidal layered dispersions.

SC-11 included Zirconium Silicate and SC-14 included Tyzor TE and both had lower sealing composition viscosities compared to SC-9, which did not contain any Group IVB metals. Even so, panels treated with either SC-11 or SC-14 had similar corrosion performance and film builds compared to panels treated with SC-9. Thus, these data also demonstrate that the inclusion of Group IVB metal-containing compounds resulted in improved corrosion performance and/or equal performance at lower sealing composition viscosity.

### Example 5. Film Build, Corrosion Performance, and Solvent Resistance on Aluminum Alloy Panels Treated with a Sealing Composition from an Electrodeposition Process

Substrate was purchased from Q-Lab (Westlake, OH) (A-412, cut only, unpolished) and were cut from 4″ by 12″ to 4″ by 3″ using a panel cutter prior to application of the alkaline cleaner.

All panels were cleaned and rinsed as described in Treatment Method K in Example 4. Panels then were treated according to Treatment Method M (immersion of panels in SC-2 as described above in Example 1) or Treatment N outlined in Table 32 below. According to Treatment Method N, panels were fully immersed in one of SC-6, SC-7, or SC-9 to SC-14. The substrate served as the anode in electrical communication with a counter-cathode and a 50 Volt potential was impressed between the electrodes for set amount of time shown in Table 33, during which the sealing compositions were maintained at ambient temperatures. No amp limit was applied and there was no ramp time. Samples were removed from the sealing compositions and allowed to drip dry for five minutes without rinsing. Samples were then placed vertically in the oven described in Treatment Method C for 5 min at 248° F.

Treated samples, run in duplicate per Treatment Method, were exposed as coated (i.e., no defect) to G-85 A3 cyclic corrosion test for 7 days. The amount of corrosion was rated visually on a scale of 1 to 5 outlined in Table 18 above after rinsing panels with DI water and wiping dry.

TABLE 32
Treatment Method N

| | |
|---|---|
| Step 1 | Alkaline cleaner (120 seconds, 125° F., spray application) |
| Step 2 | Deionized water rinse (30 seconds, 75° F., immersion |
| | application) |
| Step 3 | Deionized water rinse (30 seconds, 75° F., spray application) |
| Step 4 | Electrodeposition of one of SC-2, or SC-4 to SC-9 |
| | (50 V, 5-60 sec) |
| Step 5 | Drip dry (ambient conditions) for five minutes without rinsing |
| Step 6 | Oven Dried (5 minutes, 248° F.) |

After panels were removed from 7-day G-85 A3 cyclic corrosion testing and rated as described above, each panel was tested for solvent resistance. Solvent resistance was measured by wrapping a Wypall X80 (commercially available from Kimberly-Clark Co.) tightly around the evaluator's finger, applying acetone to the Wypall X80, and then rubbing the coating with the acetone soaked Wypall X80. The evaluator applied significant force and counted every forward and then back motion as one double rub. If the coating did not break to the substrate after 100 double rubs, a percentage of film loss was reported. Results are presented in Table 33. Data reported in Table 33 are an average of the two panels treated per Treatment Method.

TABLE 33
Treatment Compositions and Corrosion Performance of Panels Treated in Example 5

| | | Deposition | Deposition | Film | 7 day G85 | Double | % Film Loss |
|---|---|---|---|---|---|---|---|
| Treatment | Sealing | Voltage | Length | Build | corrosion | Acetone | After Double |
| Method | Composition | (Volts) | (seconds) | (mils) | performance | Rubs | Acetone Rubs |
| M | SC-7 | 0 | 30 | 0.05 | 4 | 5 | 100% |
| N | SC-7 | 50 V | 60 | 0.25 | 5 | 15 | 100% |
| N | SC-9 | 50 V | 5 | 0.64 | 5 | 100 | 49% |
| N | SC-10 | 50 V | 5 | 0.25 | 5 | 100 | 16% |
| N | SC-11 | 50 V | 5 | 0.8 | 5 | 100 | 66% |
| N | SC-12 | 50 V | 20 | 0.17 | 5 | 20 | 100% |
| N | SC-13 | 50 V | 60 | 0.25 | 5 | 20 | 100% |
| N | SC-14 | 50 V | 5 | 0.65 | 5 | 100 | 1% |

The data in Table 33 demonstrate the corrosion performance benefit of electrodepositing the sealing compositions of the present disclosure. In general, electrodepositing the sealing composition allows for thicker coatings regardless of sealer composition rheology. This was demonstrated by comparing Treatment Methods M and N, which showed significantly higher film build and better corrosion performance from the same sealing composition when electrodepositing the composition. Additionally, these data demonstrate the further increase in film build and improvements in solvent resistance achieved with the use of electrodepositing sealing compositions containing colloidal layered dispersions and/or Group IVB metal-containing components. Additionally, these data demonstrate that inclusion of carbonate in the sealing composition slows the rate of electrodeposition and allows a more controlled film build.

Whereas specific aspects of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

1. A sealing composition for treating a metal substrate comprising:
a polyolefin component; and
a colloidal layered silicate.

2. The sealing composition of claim 1, wherein:
(a) the polyolefin comprises at least one functional group;
(b) the polyolefin comprises a melt index of 1 g/10 min to 2000 g/10 min measured according to ASTM D1238 at conditions of 125° C./2.16 kg;
(c) the polyolefin comprises an acid weight percent of 2.5 weight percent to 35 weight percent measured according to ASTM 4094; and/or
(d) the sealing composition comprises the polyolefin in an amount of 0.25 percent by weight to 40 percent by weight based on total weight of the sealing composition.

3-9. (canceled)

10. The sealing composition of claim 1, wherein:
(a) the colloidal layered silicate has an average diameter of 1 nm to 2 μm measured according to transmission of electron microscopy (TEM) by suspending particles in a solvent, then drop-casting the suspension into a TEM grid and drying the suspension under ambient conditions; and/or
(b) the sealing composition comprises the colloidal layered silicate in an amount of 0.25 percent by weight to 25 percent by weight based on total weight of the sealing composition.

11. The sealing composition of claim 1, further comprising a Group IVB metal, a carbonate, an amine, an alcohol or combinations thereof.

12. (canceled)

13. The sealing composition of claim 1, wherein:
(a) the sealing composition has a solids content of at least 0.25 percent by weight based on total weight of the sealing composition;
(b) the sealing composition has a pH of 7 to 11; and/or
(c) the sealing composition has a viscosity of at least 5 cP measured using a Brookfield DV-I Prime Viscometer and a number 1 sized, 5.5 cm diameter spindle completely submerged in the sealing composition and set to a shear rate of 81 s⁻¹.

14-15. (canceled)

16. A system for treating a metal substrate comprising:
a cleaner composition; and/or
a pretreatment composition for treating at least a portion of the substrate, the pretreatment composition comprising a Group IVB metal; and
a sealing composition for treating at least a portion of the substrate treated with the cleaner composition and/or the pretreatment composition, the sealing composition comprising a polyolefin component.

17. The system of claim 16, wherein;
(a) the polyolefin component comprises at least one functional group;
(b) the polyolefin comprises a melt index of 1 g/10 min to 2000 g/10 min measured according to ASTM D1238 at conditions of 125° C./2.16 kg;
(c) the polyolefin comprises an acid weight percent of 2.5 weight percent to 35 weight percent measured according to ASTM 4094; and/or
(d) the sealing composition comprises the polyolefin in an amount of 3 percent by weight to 40 percent by weight based on total weight of the sealing composition.

18-23. (canceled)

24. The system of claim 16, wherein:
(a) the sealing composition has a solids content of at least 3 percent by weight based on total weight of the composition; and/or
(b) the sealing composition has a viscosity of at least 10 cP measured using a Brookfield DV-I Prime Viscometer and a number 1 sized, 5.5 cm diameter spindle completely submerged in the sealing composition and set to 100 RPM.

25-30. (canceled)

31. The system of claim 16, wherein the pretreatment composition further comprises an electropositive metal, lithium, molybdenum, an adhesion promoter, free fluoride or combinations thereof.

32-33. (canceled)

34. A method of treating a substrate, comprising contacting at least a portion of a surface of the substrate with the sealing composition of claim 1.

35. A method of treating a substrate comprising contacting at least a portion of the substrate with the system of claim 16.

36-37. (canceled)

38. A method of treating a substrate comprising passing electric current between a cathode and the substrate, serving as an anode, said cathode and anode being immersed in a sealing composition comprising a polyolefin component.

39. The method of claim 38, wherein:
(a) the polyolefin component comprises at least one functional group;
(b) the polyolefin component has a melt index of 1 g/10 min to 2000 g/10 min measured according to ASTM D1238 at conditions of 125° C./2.16 kg;
(c) the polyolefin component has an acid weight percent of 2.5 weight percent to 35 weight percent measured according to ASTM 4094; and/or
(d) the sealing composition comprises the polyolefin in an amount of 0.25 percent by weight to 40 percent by weight based on total weight of the sealing composition.

40-45. (canceled)

46. The method of claim 38, wherein the sealing composition further comprises colloidal silicate, a rheology modifier, an amine, an alcohol or combinations thereof.

47-48. (canceled)

49. The method of claim 38, wherein the sealing composition has a viscosity of at least 10 cP measured using a Brookfield DV-I Prime Viscometer and a number 1 sized, 5.5 cm diameter spindle completely submerged in the sealing composition and set to 100 RPM.

50. A substrate comprising a surface treated according to the method of claim 38.

51-52. (canceled)

53. The substrate of claim 58, wherein the substrate comprises a vehicle, a part, an article, a heat exchanger, an appliance, a personal electronic device, a multi-metal article, or combinations thereof.

54. The substrate of claim 53, wherein the vehicle comprises an automobile or an aircraft.

55. The substrate of claim 58, wherein the substrate comprises a three-dimensional component formed by an additive manufacturing process.

56. (canceled)

57. The substrate of claim 58, wherein the substrate demonstrates at least one of the following:
(a) a water contact angle of at least 80° measured according to ASTM D7334-08;
(b) a barrier property of at least 1E4 ohm·cm² measured using a Gamry electrochemical impedance spectroscopy conducted in quiescent 5 wt % NaCl solution after 30 minutes at open circuit potential using a Gamry Reference 600+ potentiostat in sine mode from 100 Hz to 0.01 Hz with 6 points per decade on an AC amplitude of 20 mV;
(c) a corrosion rating of at least 4 (according to rating scale described in the Examples) following 48 hr exposure to salt spray and/or 168 hr testing according to G-85A3;
(d) a ΔL of at least 0.01 following weathering test according to D4587;
(e) a wet adhesion of 5B measured according to the crosshatch adhesion test;
(f) a pit density of no more than 3 pit/cm² measured using a Keyence VR3200 3D Measuring Macroscope (surface topologies of 8.4 cm×7.6 cm at a pixel resolution of 11.8 μm);
(g) a pit depth of no more than 500 μm measured using a Keyence VR3200 3D Measuring Macroscope (surface topologies of 8.4 cm×7.6 cm at a pixel resolution of 11.8 μm); and/or
(h) a film thickness of at least 0.04 mil measured using a Fischerscope MMS device purchased from Fischer Technology Inc.

58. A substrate comprising a layer formed from the sealing composition of claim 1.

59. A substrate comprising a layer formed from the sealing composition of claim 38.
